(19) United States
(12) Patent Application Publication
(10) Pub. No.: US 2026/0244391 A1
(43) Pub. Date: Aug. 20, 2026

(54) RECIPE GENERATION WITH MACHINE LEARNING AND SYNCHRONIZED RECIPE USE WITH CONNECTED KITCHEN APPLIANCES

(71) Applicant: Adaptics Limited, Dublin (IE)

(72) Inventors: Benjamin Harris, Dublin (IE); Jonathan McCauley, Dublin (IE); Philip Pantelides, Bath (GB); Anthony Sullivan, Bath (GB); Graham O’Sullivan, Kilmeague (IE); Timothy James Redfern, Clonbur (IE)

(73) Assignee: Adaptics Limited, Dublin (IE)

(21) Appl. No.: 19/160,745

(22) PCT Filed: Mar. 6, 2024
(86) PCT No.: PCT/EP2024/055826

§ 371 Date: Aug. 28, 2025

Related U.S. Application Data
(60) Provisional application No. 63/450,299, filed on Mar. 6, 2023.

(51) Int. Cl. G06F 3/14; G06F 3/04817

(52) U.S. Cl. CPC G06F 3/1454; G06F 3/04817

(57) ABSTRACT

A recipe is stored on a recipe framework. A user has one or more devices and one or more appliances. A recipe program presents recipe information using a device interface on a first device and/or on an appliance interface of a first appliance. The device or appliance interfaces track user interactions with the recipe program. A version of the recipe's progress and state is maintained in said framework. While the recipe is in progress, and in response to the user switching to a second device and/or appliance, presenting recipe information on the second device and/or appliance based on the version of the progress and state of the recipe maintained in the recipe framework. The second device or second appliance obtains the version of the progress and state from the recipe framework. The device and appliance user interfaces present a consistent and contextual view of the state of the recipe.

### RELATED AND/OR INCORPORATED APPLICATIONS

This application claims the benefit of U.S. patent application No. 63/450,299, filed Mar. 6, 2023, the entire contents of which are hereby fully incorporated herein by reference for all purposes.

The entire contents of the following U.S. patent applications are hereby fully incorporated herein by reference for all purposes:
(1) Ser. No. 16/389,894, filed Apr. 19, 2019,
(2) 63/410,340, titled “Synchronized Recipe Use With Connected Kitchen Appliances,” filed Sep. 27, 2022, and
(3) 63/433,413, titled “Weighing User Interface for Smart Recipes,” filed Dec. 16, 2022.

### COPYRIGHT STATEMENT

This patent document contains material subject to copyright protection. The copyright owner has no objection to the reproduction of this patent document or any related materials in the United States Patent and Trademark Office files, but otherwise reserves all copyrights whatsoever.

### FIELD OF THE INVENTION

Aspects of this invention relate to improving user experiences with connected kitchen appliances. More specifically, aspects of the invention relate to a user interface (UI) for connected kitchen appliances.

### BACKGROUND

Home chefs can now access various innovative kitchen appliances with multiple cooking functions and time-saving features. However, many users struggle to understand how to use these appliances beyond the limited range of sample recipes provided by the manufacturer.

Connecting these appliances to home networks/the internet is a popular option with both consumers and manufacturers, with the potential to link recipe discovery, ingredient supply, and cooking in a seamless guided journey. However, there is a tendency for connected appliances to each exist in a separate ecosystem with their user interface, mobile app, and recipes.

The inventors have created systems, methods, and devices for using recipes with connected kitchen appliances (as described in U.S. application Ser. Nos. 16/389,894 and 63/410,340, whose entire contents are incorporated herein by reference for all purposes). The techniques described enable home chefs to access recipes from multiple sources, giving them the confidence to utilize their appliances to their full potential and the convenience of following a connected guided cooking flow. However, the use of connected recipes may be impeded by the varying user interfaces of connected devices.

Therefore, it is desirable and an object hereof to offer standardized user interface components that can function effectively across various appliances.

### SUMMARY

Aspects of the present invention are specified in the claims and the below description Preferred embodiments are particularly specified in the dependent claims and the description of various embodiments.

A system of one or more computers can be configured to perform particular operations or actions by virtue of having software, firmware, hardware, or a combination of them installed on the system that, in operation, causes or cause the system to perform the actions. One or more computer programs can be configured to perform particular operations or actions by virtue of including instructions that, when executed by a data processing apparatus, cause the apparatus to perform the actions.

One general aspect includes a method in a system in which a recipe is stored on a recipe framework. The method also includes a recipe program presenting recipe information to the user using a device user interface on a first of said one or more devices and/or on an appliance user interface of a first appliance of said one or more appliances. The method also includes tracking user interactions with the recipe program via the device user interface or the appliance user interface. The method also includes monitoring the progress and state of the recipe. The method also includes, based on said monitoring, maintaining in said recipe framework a version of the progress and state of the recipe. The method also includes, while the recipe is in progress and in response to the user switching to a second device of said one or more devices and/or to a second appliance of said one or more appliances, presenting recipe information on a second device user interface and/or on a second appliance user interface based on the version of the progress and state of the recipe maintained in the recipe framework, where the second device or second appliance obtains the version of the progress and state from the recipe framework. The method also includes where the device user interfaces and the appliance user interfaces present and may include a contextual view of the state of the recipe. Other embodiments of this aspect include corresponding computer systems, apparatus, and computer programs recorded on one or more computer storage devices, each configured to perform the actions of the methods.

Implementations may include one or more of the following features, alone or in combination(s):
The method where the device user interfaces and the appliance user interfaces may include one or more contextual icons said icons representing the state of the recipe. At least some contextual icons correspond to virtual buttons or switches used to control aspects of said recipe and/or aspects of one or more appliances. The one or more devices are selected from a personal computer, a cell phone, a tablet computer, a desktop computer, a TV, a smartwatch, a voice assistant, or an appliance UI; and where the one or more appliances are selected from cooking and food preparation appliances. The version of the progress and state of the recipe maintained in the recipe framework is considered a true version of the progress and state of the recipe. The recipe framework is accessible via one or more interfaces and where a device or appliance obtains the true version of the progress and state from the recipe framework via said one or more interfaces. The recipe framework, where the true version of the progress and state of the recipe is based on received streams of events and/or state data coming from the one or more devices and/or the one or more appliances. If there is a discrepancy between versions of the progress and state of the recipe, the progress and state maintained by the recipe framework will govern. State data from an appliance includes information about the current state of the appliance. The recipe may include a list of one or more ingredients and a list of recipe steps, and where the state of the progress and state of the recipe may include information about which recipe step or steps have been completed. The recipe framework determines which one or more appliances to use for the recipe based on information about appliances available to the user. A determination of which appliances to use for the recipe is made when the user selects the recipe, and using user data maintained by the recipe framework, the user data, including appliance data. The recipe determines which of the one or more appliances are to be used, and where a determination of which of the one or more appliances are to be used is made after the acts of the method are performed. Implementations of the described techniques may include hardware, a method or process, or computer software on a computer-accessible medium.

Implementations of the described techniques may include hardware, a method or process, or computer software on a computer-accessible medium.

Below is a list of method (or process) embodiments. Those will be indicated with the letter “P.” Whenever such embodiments are referred to, this will be done by referring to “P” embodiments.
P1. A method in a system in which a recipe is stored on a recipe framework, the method comprising by a user having one or more devices and one or more appliances, at least some of said one or more devices having corresponding device user interfaces, and at least some of said one or more appliances having corresponding appliance user interfaces, the method comprising:
a recipe program presenting recipe information to the user using a device user interface on a first of said one or more devices and/or on an appliance user interface of a first appliance of said one or more appliances;
tracking interactions of the user with the recipe program via the device user interface or the appliance user interface;
monitoring progress and state of the recipe;
based on said monitoring, maintaining in said recipe framework a version of the progress and state of the recipe, and
while the recipe is in progress, and in response to the user switching to a second device of said one or more devices and/or to a second appliance of said one or more appliances, presenting recipe information on a second device user interface and/or on a second appliance user interface based on the version of the progress and state of the recipe maintained in the recipe framework, wherein the second device or second appliance obtains the version of the progress and state from the recipe framework,
wherein the device user interfaces and the appliance user interfaces present a consistent and contextual view of the state of the recipe.
P2. The method of process embodiment(s) P1, wherein the device user interfaces and the appliance user interfaces comprise one or more contextual icons, said icons representing the state of the recipe.
P3. The method of process embodiments P1 or P2, wherein at least some of said contextual icons correspond to virtual buttons or switches used to control aspects of said recipe and/or aspects of one or more appliances.
P4. The method of any of the process embodiments, wherein the one or more devices are selected from:
a personal computer, a cell phone, a tablet computer, a desktop computer, a TV, a smartwatch, a voice assistant, or an appliance UI; and
wherein the one or more appliances are selected from cooking and food preparation appliances.
P5. The method of any of the process embodiments, wherein the version of the progress and state of the recipe maintained in the recipe framework is considered a true version of the progress and state of the recipe.
P6. The method of any of the process embodiments, wherein, if there is a discrepancy between versions of the progress and state of the recipe, the progress and state maintained by the recipe framework will govern.
P7. The method of process embodiment(s) P5, wherein the recipe framework is accessible via one or more interfaces and wherein a device or appliance obtains the true version of the progress and state from the recipe framework via said one or more interfaces.
P8. The method of process embodiment(s) P7, wherein the recipe framework, wherein the true version of the progress and state of the recipe is based on received streams of events and/or state data coming from the one or more devices and/or the one or more appliances.
P9. The method of any of the process embodiments, wherein state data from an appliance includes information about a current state of the appliance.
P10. The method of any of the process embodiments, wherein the recipe comprises a list of one or more ingredients and a list of recipe steps, and wherein the state of the progress and state of the recipe comprises information about which recipe step or steps have been completed.
P11. The method of any of the process embodiments, wherein the recipe framework determines which one or more appliances to use for the recipe based on information about appliances available to the user.
P12. The method of any of the process embodiments, wherein a determination of which appliances to use for the recipe is made when the user selects the recipe, and using user data maintained by the recipe framework, the user data, including appliance data.
P13. The method of any of the process embodiments, wherein the recipe determines which of the one or more appliances are to be used, and wherein a determination of which of the one or more appliances are to be used is made after the acts of the method are performed.

Below is a list of computer-readable medium embodiments. Those will be indicated with the letter “C.” Whenever such embodiments are referred to, this will be done by referring to “C” embodiments.
C14. A computer-readable medium with one or more computer programs stored therein that, when executed by one or more processors of a device, cause the one or more processors to perform the operations of the method of any of the process embodiments P1-P13.
C15. The computer-readable medium of embodiment C14, wherein the medium is non-transitory.

Other embodiments include:
A16. An article of manufacture comprising non-transitory computer-readable media having computer-readable instructions stored thereon, the computer-readable instructions including instructions for implementing a computer-implemented method, said method operable on a device comprising hardware including memory and at least one processor and running a service on said hardware, said method comprising the method of any one of embodiments P1-P13.
D18. A device comprising:
(a) hardware, including memory and at least one processor, and
(b) a service running on said hardware, wherein said service is configured to perform the method of any one of embodiments P1-P13.
S19. A system comprising at least one device according to device embodiment(s) D18.

The above features and additional details of the invention are described further in the examples herein, which are intended to illustrate the invention further but not limit its scope in any way.

### BRIEF DESCRIPTION OF THE DRAWINGS

Objects, features, and characteristics of the present invention, as well as the methods of operation and functions of the related elements of structure and the combination of parts and economies of manufacture, will become more apparent upon consideration of the following description and the appended claims with reference to the accompanying drawings, all of which form a part of this specification. The drawings are not to scale.

FIGS. 1A and 1B depict aspects of an exemplary system employing a recipe framework according to exemplary embodiments hereof;

FIGS. 2A and 2B depict aspects of devices and appliances, respectively;

FIGS. 3A, 3B, and 3C depict aspects of recipe data, appliance data, and user data, respectively, according to exemplary embodiments hereof;

FIGS. 4A-4V, 5A-5D, and 6A-6C depict aspects of user interfaces according to exemplary embodiments hereof;

FIG. 7 depicts aspects of using a recipe framework according to exemplary embodiments hereof, and

FIG. 8 depicts aspects of computing according to exemplary embodiments hereof.

### DETAILED DESCRIPTION OF EXEMPLARY EMBODIMENTS

### Glossary and Abbreviations

As used herein, unless used otherwise, the following terms or abbreviations have the following meanings:

API means Application Programming Interface.

JSON-LD (JSON for Linked Data) encodes linked data using JSON (JavaScript Object Notation).

The term “mechanism,” as used herein, refers to any device(s), process(es), service(s), or a combination thereof. A mechanism may be implemented in hardware, software, firmware, using a special-purpose device, or any combination thereof. A mechanism may be integrated into a single device, or it may be distributed over multiple devices. The various components of a mechanism may be co-located or distributed. The mechanism may be formed from other mechanisms. In general, as used herein, the term “mechanism” may thus be considered shorthand for the term device(s) and/or process(es) and/or service(s).

### DESCRIPTION

### Overview and Structure

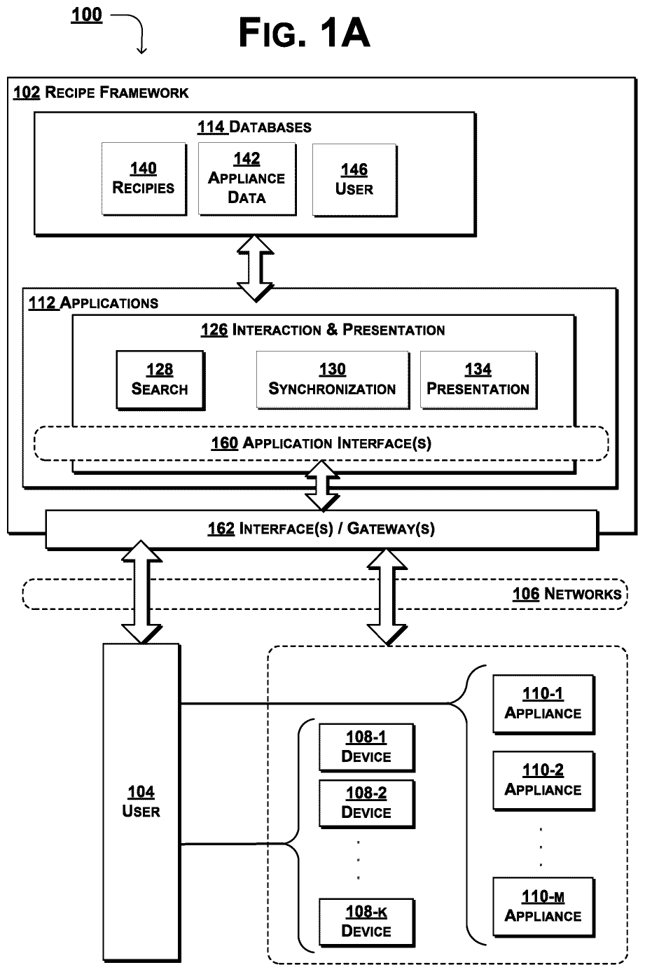

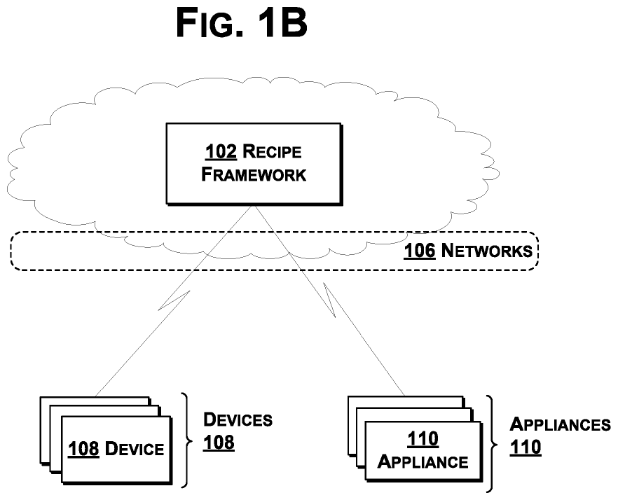

FIG. 1A shows aspects of an exemplary system 100 employing a recipe framework 102 described below in greater detail. As shown in the drawing, a recipe framework 102 may be accessed by users 104, e.g., via one or more networks 106 (e.g., the Internet). Different types of users are contemplated. For example, the users 104 may be appliance manufacturers, appliance end users, or others. Each user 104 has one or more devices 108 and one or more appliances 110 associated therewith. These devices 108 and appliances 110 are discussed in greater detail below. However, each device 108 and appliance 110 includes (or is) a computing device (also discussed in greater detail below). Users 104 may access the recipe framework 102 using one or more of their devices 108 and/or appliances 110, as known in the art.

As shown in FIG. 1A, the recipe framework 102 (sometimes called the recipe system, platform, or backend) may comprise various mechanisms or applications 112 (e.g., software applications) and one or more databases 114, described below. The applications 112 may generally interact with the one or more databases 114.

The database(s) 114 may comprise multiple separate or integrated databases, at least some of which may be distributed. The database(s) 114 may be implemented in any manner, and when made up of more than one database, the various databases need not all be implemented in the same manner. The system is not limited by the nature or location of the database(s) 114 or how they are implemented.

Each application 112 is essentially a mechanism (as defined above, e.g., a software application) that may provide one or more services (internal or external) via an appropriate interface. Although shown as separate mechanisms for this description, it should be appreciated that some or all of the various applications 112 may be combined. Similarly, a mechanism shown here as a single mechanism may comprise multiple component mechanisms. The various applications 112 may be implemented in any manner and need not all be implemented in the same manner (e.g., with the same languages, interfaces, or protocols).

The applications 112 may include one or more of the following: interaction and presentation mechanism(s) 126, which may include search mechanism(s) 128, synchronization mechanism(s) 130, one or more smart mechanism(s) 132, and presentation mechanism(s) 134.

Note that the above list of applications/mechanisms is exemplary and is not intended to limit the scope of the system 100 in any way. Those of ordinary skill in the art will appreciate and understand, upon reading this description, that the system 100 may include any other types of data processing mechanisms and/or other types of mechanisms that may be necessary for the system 100 to generally perform its functionalities as described herein. In addition, as should be appreciated, embodiments or implementations of the system 100 need not include all of the mechanisms listed, and some or all of the mechanisms may be optional.

The database(s) 114 may include one or more of the following database(s): recipes database(s) 140, appliance database(s) 142, and user database(s) 146.

The above list of databases is exemplary and is not intended to limit the scope of the system 100 in any way.

The recipe system/framework 102 may access one or more external systems and databases (not shown) to obtain data (e.g., recipes) therefrom.

Various applications 112 in the recipe system/framework 102 may be externally accessible via an interface(s) 160. These interfaces 160 may be provided in the form of APIs or the like, made accessible to users 104 via one or more gateways and interfaces 162. For example, the search mechanism(s) 128 may provide APIs thereto (via the interface(s) 160). The recipe system/framework 102 may provide external access to aspects of the system (to users 104) via appropriate gateways and interfaces 162 (e.g., via a web-based mechanism and/or a mechanism running on a user's device).

As should be appreciated, the recipe framework 102 comprises various mechanisms that may be implemented on one or more computer systems (described in greater detail below). The one or more computer systems that make up the recipe framework 102 may be co-located but need not. The one or more computer systems that make up the recipe framework 102 need not be homogeneous. While specially programmed general-purpose computers may be used to implement some or all of the recipe framework 102, those of skill in the art will understand, upon reading this description, that some aspects may be implemented using specialized hardware or processors.

### Cloud Access

From the point of view of devices 108 or appliances 110, the recipe framework 102 may sometimes be referred to as being in the cloud, and accessing the recipe framework 102 may be referred to as cloud access. For example, as shown in FIG. 1B, the devices 108 and appliances 110 access the recipe framework 102 in the cloud. The access may be via one or more networks 106, some of which may also be in the cloud.

User Devices & Appliances

As noted above, a user 104 may have one or more devices 108 and one or more appliances 110 associated therewith.

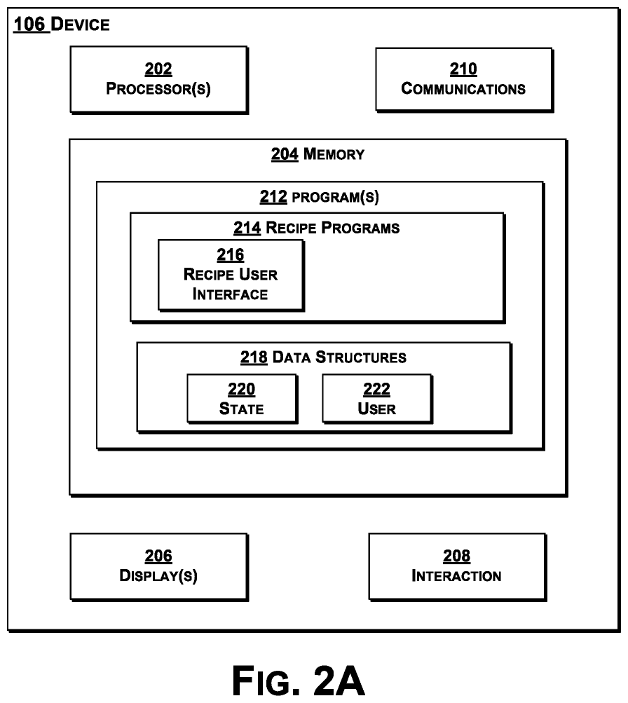

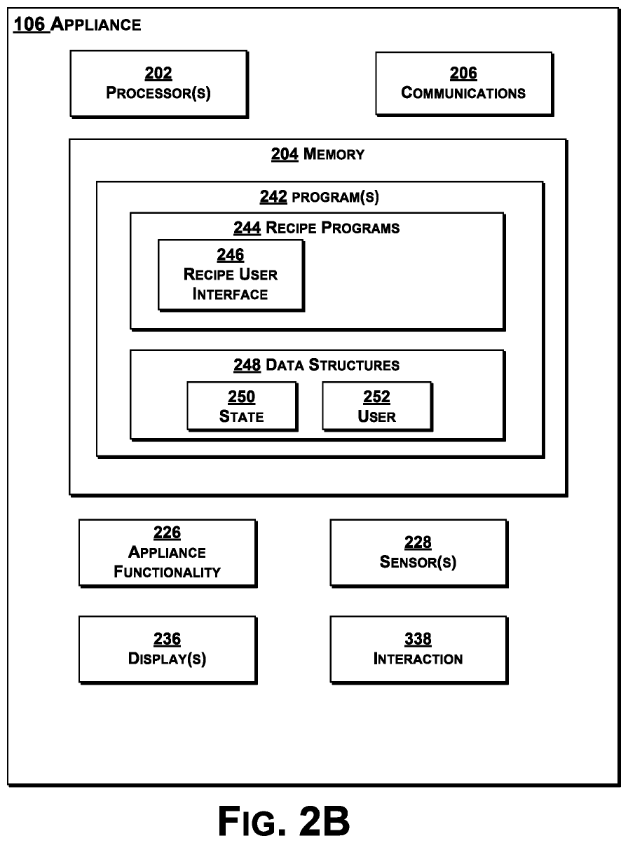

With reference to FIG. 2A, a user device 108 is essentially a computing device. It includes one or more processors 202, memory 204, a display 206, and one or more interaction mechanism(s) 208 (e.g., a keyboard or the like). The interaction mechanism(s) 208 may be integrated into the display (e.g., a touch screen, virtual keyboard, or the like). The device also includes communications mechanism(s) 210 supporting communication with external devices and systems. For example, the communications mechanism(s) 210 may support wired or wireless communication (e.g., Bluetooth, WiFi, Ethernet, mobile, cellular, etc.) with other devices 108 and appliances 110. The communications mechanism(s) 210 may also support communication with the recipe framework 102, e.g., via the network(s) 106.

The device's memory 204 may store programs 212, including recipe programs 214. The recipe programs 214 may include or support recipe user interfaces 216. The memory may also store data 218 supporting the programs 212. The data 218 may include data 218 for the recipe programs 214, which may include state data 220 and user data 222.

A device 108 may be, e.g., a personal computer, a cell phone, a tablet computer, a desktop computer, or the like. A device may be standalone or integrated into other devices (e.g., a set-top box, an appliance, or the like).

With reference to FIG. 2B, an appliance 110 includes one or more mechanism(s) 226 and sensors 228 supporting the appliance's functionality (as an appliance). For example, if the appliance is an oven, the mechanisms 226 and sensors 228 support the operation of the oven (as an oven). The appliance may include one or more processors 232, memory 234, a display 236, and one or more interaction mechanism(s) 238 (e.g., a keypad, buttons, or the like). The interaction mechanism(s) 238 may be integrated into a display (e.g., a touch screen, virtual keyboard, or the like). The device also includes communications mechanism(s) 240 that support communication with external devices and systems. For example, the communications mechanism(s) 240 may support wired or wireless communication (e.g., Bluetooth, WiFi, Ethernet, etc.) with other devices 108 and appliances 110. The communications mechanism(s) 240 may also support communication with the recipe framework 102, e.g., via the network(s) 106.

The appliance's memory 234 may store programs 242, including recipe programs 244. The recipe programs 244 may include or support recipe user interfaces 246. The memory may also store data 248 supporting the programs 242. The data 248 may include data for the recipe programs 244, which may include state data 250 and user data 252.

An appliance 110 may be, e.g., an oven, a pressure cooker, or the like. An appliance may be standalone, or it may be integrated into other appliances.

### Databases and Data

### Recipes and Recipe Data

The recipe framework 102 provides structured recipes, referred to herein as “connected recipes.” The recipe framework 102 may obtain structured (connected) recipes from external sources, and/or it may generate them from textual (“plain old”) recipes or semi-structured recipes.

### Connected Recipes

A connected recipe, according to exemplary embodiments hereof, is a machine-readable recipe with some or all of the following properties:
A connected recipe may be used, alone or in conjunction with other devices, to control connected appliances.
A connected recipe may also be structured or annotated to allow for and support recipe presentation to users on user devices and appliances.
A connected recipe may be normalized to remove ambiguity from a plain recipe
A connected recipe may be standardized to use standard measures and terminology
Other algorithms (e.g., smart algorithms 132) may use a connected recipe to transform the recipe (e.g., by scaling or ingredient substitution) or to determine information about the food produced by the recipe (e.g., nutritional information).

This list of properties of a connected recipe is not exclusive or limiting.

An example connected (smart) recipe is shown in Appendix A hereto (Appendix C of application No. 63/410,340).

Connected recipes may be determined or generated, e.g., as described in U.S. Application No. 63/410,340 (e.g., by the machine learning that operates on annotated recipes and produces corresponding connected recipes).

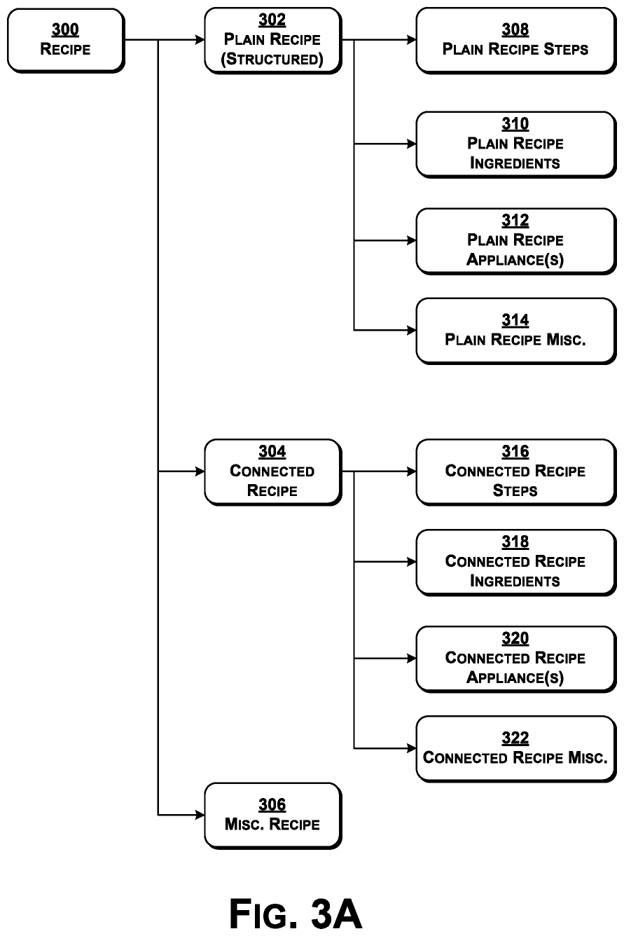

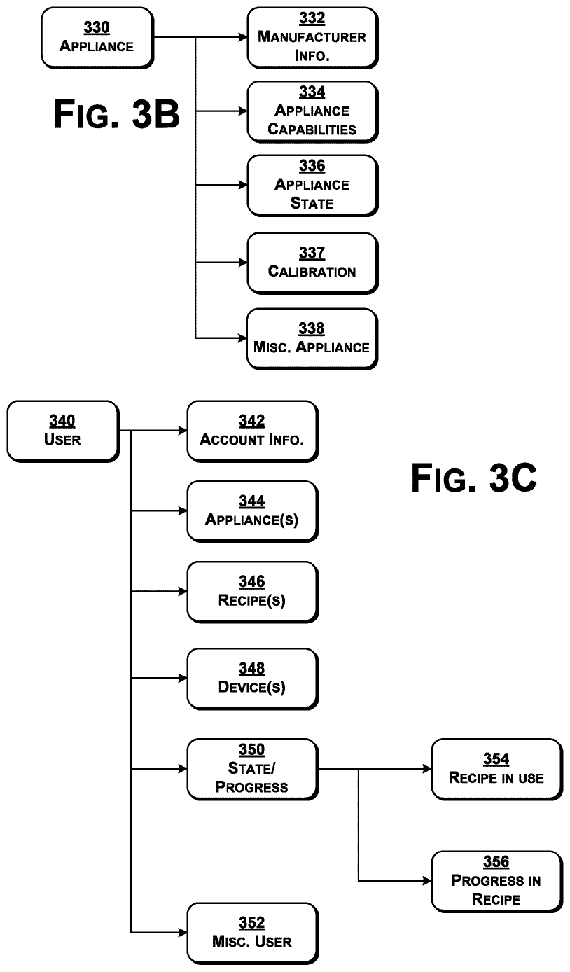

FIG. 3A shows an exemplary logical organization of recipe data 300 (e.g., in recipes database(s) 140 in FIG. 1A, recipe data 216 in the device 108 in FIG. 2A, and recipe data 246 in the appliance 110 in FIG. 2B). With reference to FIG. 3A, recipe data 300 may include plain recipe data 302 (which may be semi-structured, e.g., using JSON-LD), connected recipe data 304, and miscellaneous recipe data 306. The connected recipe data 304 preferably contains recipes structured by the recipe framework 102. These connected recipes may have corresponding plain recipes in the plain recipe data 302.

The plain recipe data 302 may include plain recipe step data 308, plain recipe ingredient data 310, plain recipe appliance(s) data 312, and other miscellaneous plain recipe data 314.

The connected recipe data 304 may include connected recipe step data 316, connected recipe ingredient data 318, connected recipe appliance(s) data 320, and other miscellaneous connected recipe data 322 (e.g., connected recipe metadata). The connected recipe metadata may include cooking capability requirements (e.g., “bake”) and appliance settings (e.g., “high”) from the cooking knowledge graph 148. Rather than requiring a specific manufacturer's appliance, this allows appliance capability resolution at runtime. The cooking capability, setting, and ingredients requirements belong to individual steps rather than the recipe as a whole.

### Appliance Data

FIG. 3B shows an exemplary logical organization of appliance data 330 (e.g., in appliance database(s) 142 in FIG. 1A). With reference to FIG. 3B, appliance data 330 may include manufacturer information 332, appliance capabilities 334, appliance state 336, appliance calibration data 337, and miscellaneous appliance data 338. An appliance's state data 336 may include information about the current state of the appliance (e.g., if the appliance is an oven, the appliance state data may include temperature data determined by the oven's thermometer (sensors 228)).

### User Data

FIG. 3C shows an exemplary logical organization of the user data 340 (e.g., in the user database(s) 146 in FIG. 1A, user data 222 in the device 108 in FIG. 2A, and user data 252 in the appliance 110 in FIG. 2B).

With reference to FIG. 3A, user data 340 may include the following user account information 342, appliance data 344, including details about the appliances associated with the user, recipe data 346, which may include the user's recipes, device data 348, including details about the devices associated with the user, state/progress data 350, and miscellaneous user data 352

A user's appliance data 344 is preferably appliance data 320, and from the appliance data 344, the recipe framework 102 can determine what appliances a user has and the capabilities of those devices.

A user's recipe data 346 is preferably recipe data 300 and may include connected recipes (e.g., already processed by the recipe framework 102).

If a user is in the process of using a recipe (preparing food with a recipe), the user's state/progress data 350 preferably indicates what recipe is being used and the user's current progress/state within that recipe (e.g., what steps have already been completed).

A connected recipe 460 may include some or all connected recipe data 304 (FIG. 3A), including connected recipe step data 316, connected recipe ingredient data 318, connected recipe appliance data 320, and other miscellaneous connected recipe data 322.

A connected recipe 460 may include ingredient lists, step descriptions, and step metadata (e.g., ingredients and appliance data) required for guided cooking. The connected recipe 460 may be used to present a guided cooking flow, e.g., within an application (app) on a user's computing device and/or on a connected appliance, as discussed below.

### Smart Kitchen Algorithms

Embodiments and implementations hereof may be used to implement so-called smart kitchen algorithms. Such smart kitchen algorithms allow the platform to apply culinary expertise automatically to adapt a recipe to achieve desired results.

Implementations of the recipe framework 102 may include some or all of the following smart kitchen algorithms: calibration, recipe scaling, and ingredient substitutions. These smart kitchen algorithms are discussed in greater detail here and in application No. 63/410,340.

### Calibration

Calibration of appliances, ingredients, and recipes allows establishing a mapping between the original version of a recipe, the canonical form based on standardized capabilities and ingredients, and a calibrated recipe using the optimal settings to be used in a specific context to achieve the best results.

Connected appliances may incorporate calibrated sensors, allowing performance to be monitored at runtime.

### Recipe Scaling

Recipe scaling is a feature that allows the quantity of food provided by a recipe to be adjusted.

In its simplest form, recipe scaling involves adjusting the quantity of ingredients in a fixed ratio. Scaling by portion allows the recipe to be adjusted to feed a given number of people. Scaling based on an ingredient amount allows the chef to adapt a recipe limited by the amount of one or more ingredients. Scaling recipes may allow some ingredients to scale non-linearly. For example, the quantity of raising agent in baking required scales proportionally to a baking container's surface area, not the ingredients' volume. This may also be approximated using a logarithmic scaling factor.

Raising agents used in recipes may also be scaled to take into account air pressure changes caused by altitude.

Scaling for container size allows a chef to prepare a recipe based on available containers, allowing for rising.

Adjusting cooking time for a scaled recipe. This can take into account the physical form of the food, for example:
A roast of meat will take time proportional to the cube root of the volume/mass
A cake will take time proportional to the shortest dimension of the container
Muffins in tins should not take longer if more tins are used

### Ingredient Substitutions

Ingredient substitutions may offer guidance where the original ingredient is unavailable or does not meet the user's food preference. Ingredient substitutions may require scaling of the substitute.

Ingredient substitutions may include simple, full, or full recipe substitutions.

In a simple substitution, one ingredient is substituted for another (e.g., blueberries for raspberries) with a scaling factor.

With full substitutions, one ingredient may be replaced by more than one other. With full substitutions, context and purpose may be required (e.g., 1 tablespoon of tapioca starch, blended with 3 teaspoons of water, as a vegan substitute for one egg used as a binder/thickener). The ingredient context/purpose may be explicitly tagged in recipe metadata in the connected recipe. It may also be output from the machine learning pipeline.

Full recipe conversions (e.g., to vegan, gluten-free, kosher versions of a recipe) may filter tags (e.g., vegan or gluten-free, or kosher) in candidate ingredient substitutions to infer alternative recipe versions. Full recipe conversions may also be the subject of machine learning.

Full recipe conversions may use simple or full substitutions to substitute some ingredients.

### Usage and Use Cases

Exemplary non-limiting uses and use cases of system 100 are described here. Those of skill in the art will understand, upon reading this description, that different and/or other uses and use cases are possible and are contemplated here.

### Using Connected Recipes

A connected recipe (either acquired from a library or generated) may be used by a user 104 in conjunction with the recipe framework 102.

An example of a user using a connected recipe is described here with reference to FIG. 1A. In this example, the user 104 has k devices 108-1, 108-2 . . . 108-k (individually and collectively devices 108) and m appliances 110-1, 110-2 . . . 110-m (individually and collectively appliances 110).

For this example, assume that the user has obtained a connected recipe (e.g., from their library).

Depending on which device or appliance the user uses, the recipe (the steps, ingredients, progress, etc.) may be presented differently. For example, if a device 108-i is a tablet (e.g., an Apple iPad or the like), a recipe program 214 having a recipe user interface 216 (FIG. 2A) may be used to present the recipe to the user on the device's display 206. The user may interact with the recipe program 214 via the user interface 216, using, e.g., the interaction mechanism(s) 208. Similarly, if the user is viewing/using the recipe on an appliance 110-p, then (with reference again to FIG. 2B), the appliance's recipe programs 244 may use the appliance's recipe user interface 246 to present aspects of the recipe on the appliance's display(s) 236. The user may interact with the recipe program 244 on the appliance via the user interface 246, using, e.g., the appliance's interaction mechanism(s) 238.

The term “user interface” (or UI) refers to any interface that allows a user to control an aspect of a system or device. A UI may be implemented in hardware, software, or a combination thereof. A UI may include graphical elements and virtual and/or real controls (e.g., dials, buttons, etc.). When implemented with virtual controls, the controls may take the form of icons displayed on a screen. The icons may be static or dynamic and may vary to display state information. For example, an icon may represent a button displaying the time elapsed or remaining for a particular recipe step. A UI may be part of or comprise a personal computer, a cell phone, a tablet computer, a desktop computer, a TV, a smartwatch, a voice assistant, or an appliance UI.

### The Standardized User Interface

The recipe framework 102—the platform—may feature several standardized UI components that function seamlessly across various devices, screens, sizes, and usage scenarios. This includes mobile applications, widgets on mobile operating systems, the appliances themselves, and even smartwatches. Thus, e.g., the user's device recipe user interface 216 and appliance(s) recipe user interface(s) 246 are standardized and consistent, allowing a user to move from device to device while maintaining a consistent view of the state of a recipe.

A “widget” may be a graphical user interface component that displays information and/or enables a user to interact with an application in a specific way. A widget may refer to code (software) that implements aspects of the interaction and information display.

Various roles have been identified for each UI element, which can be applied across different contexts. These UI elements are presented in a consistent and standardized manner, thereby establishing a recognizable interaction pattern that users of any smart appliance brand can instinctively and easily understand on the platform.

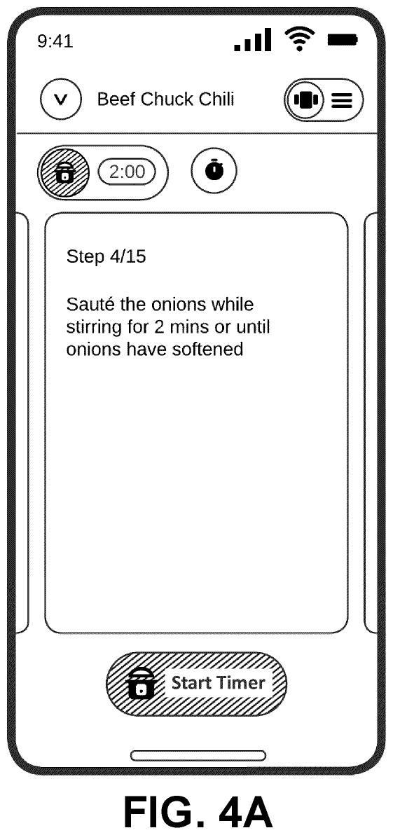

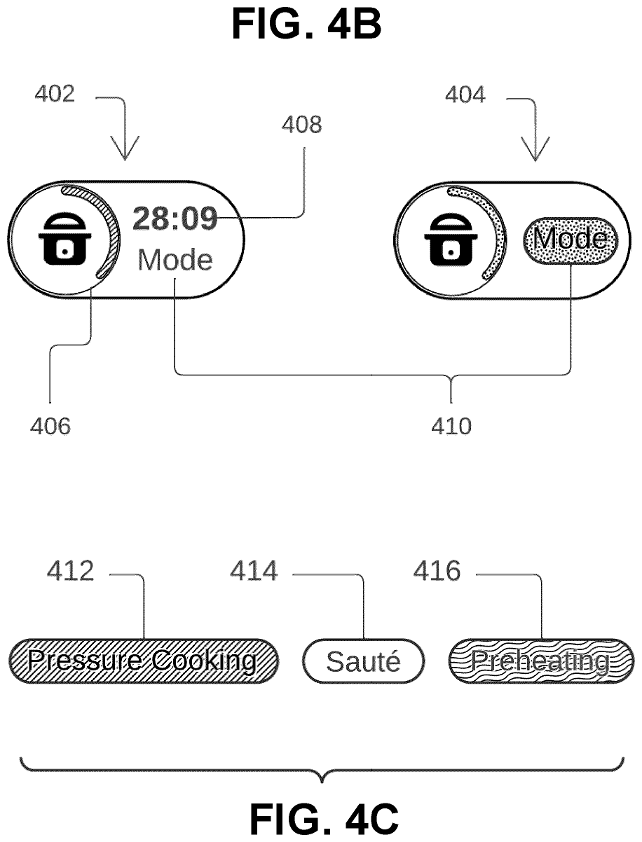

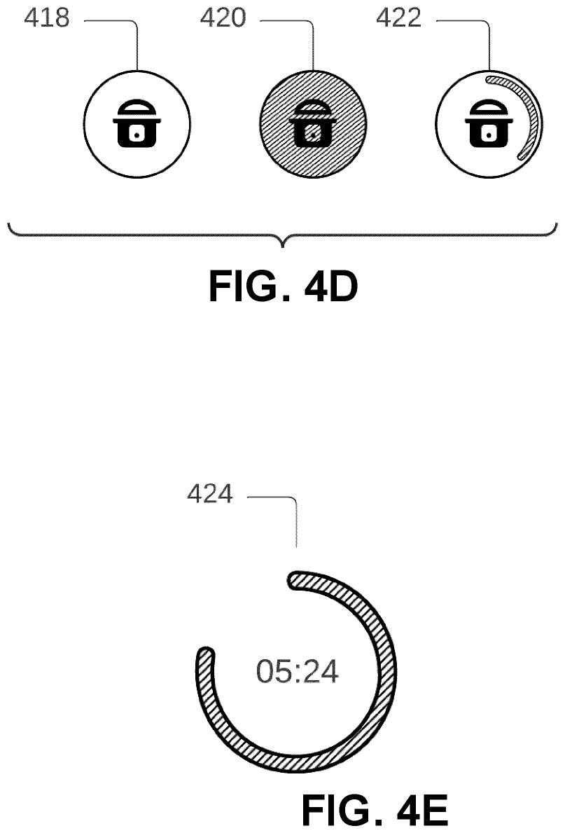

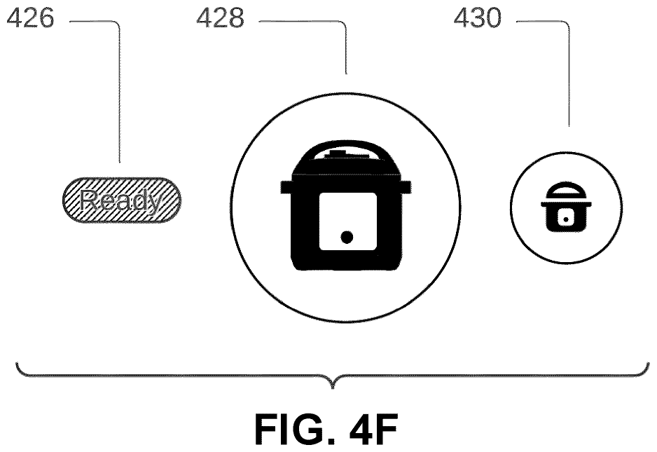

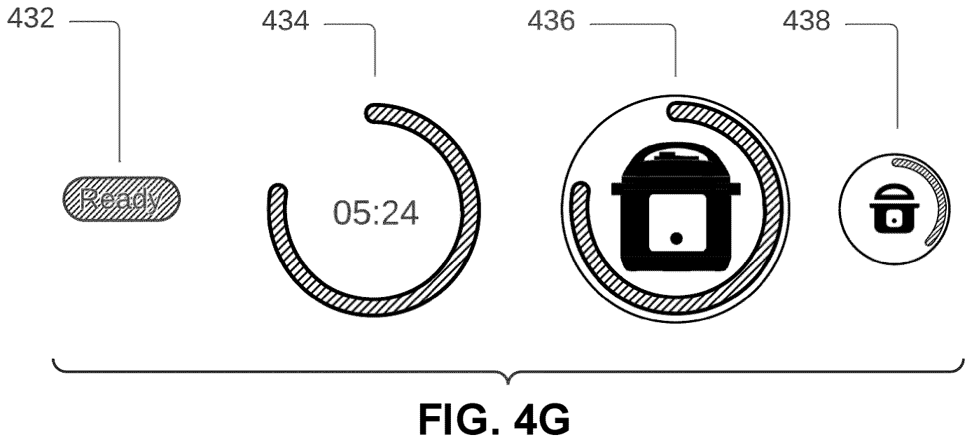

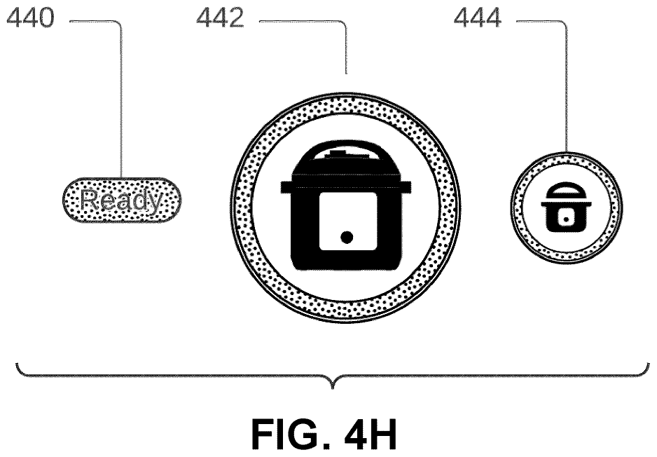

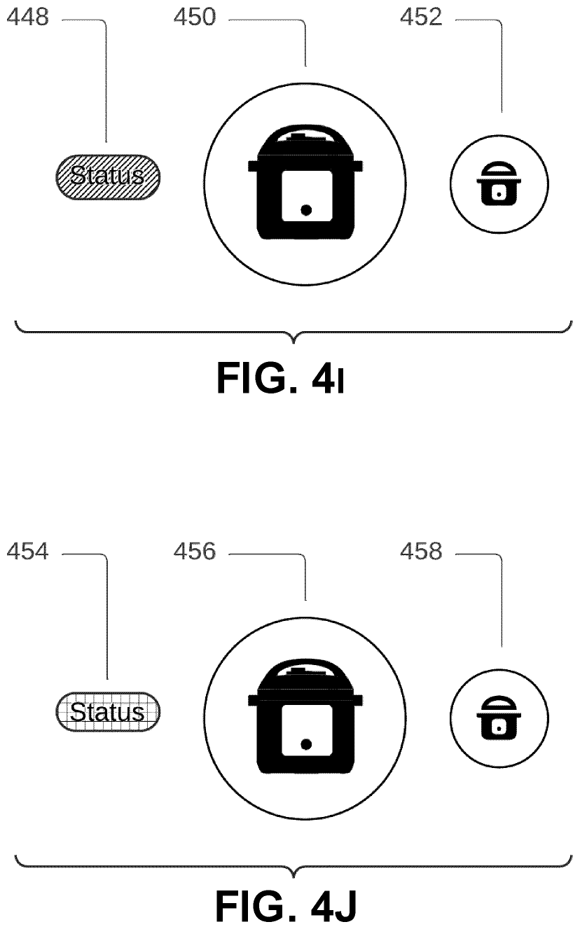

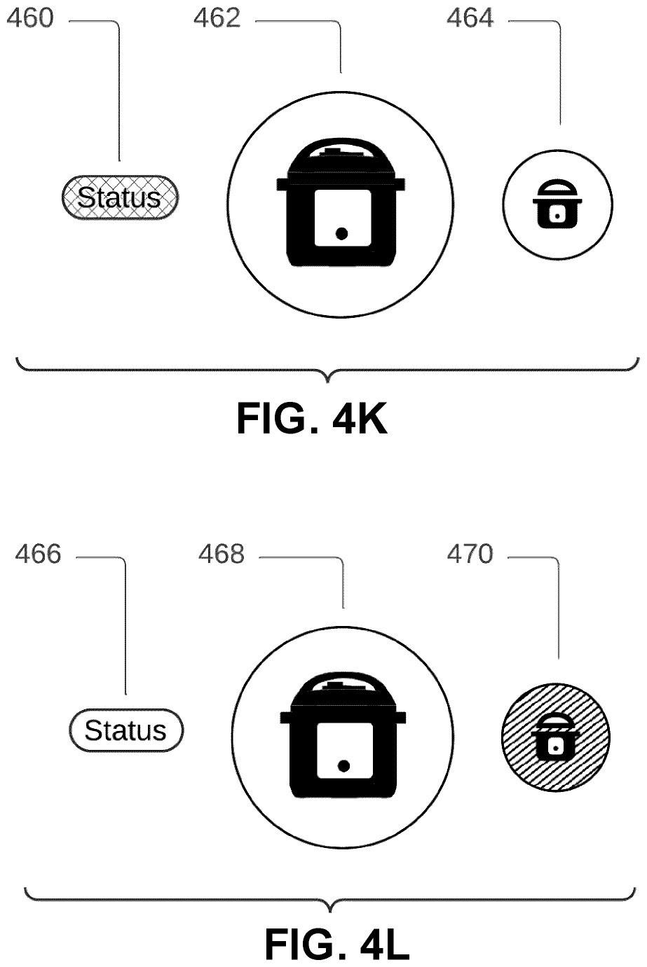

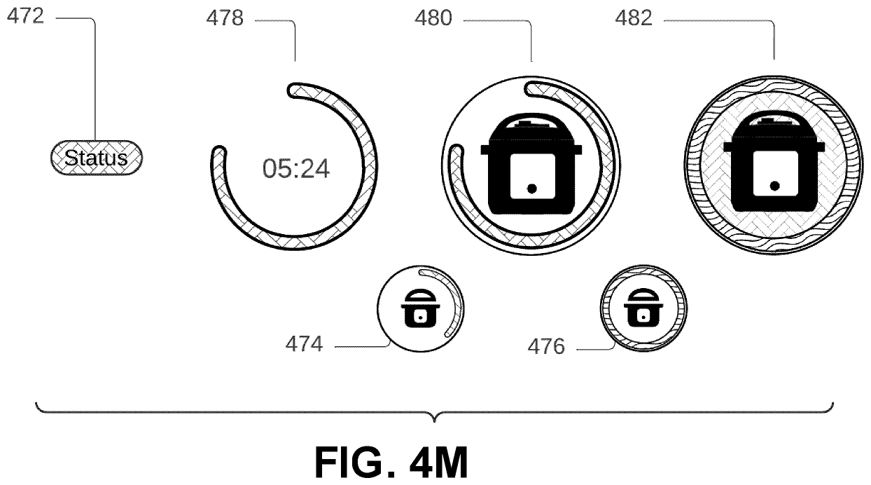

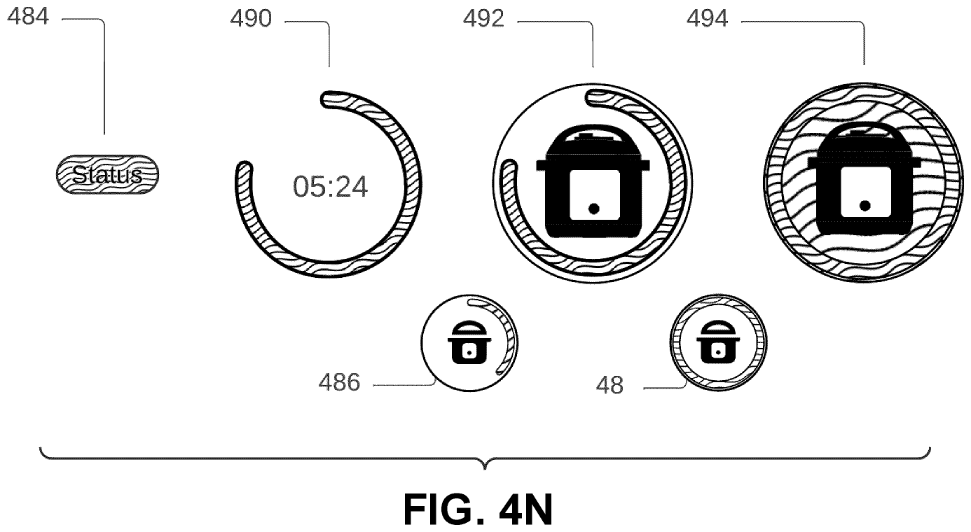

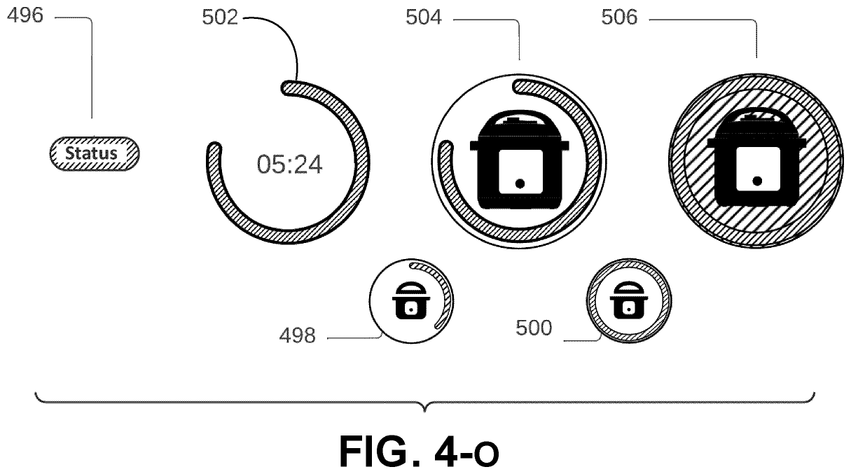

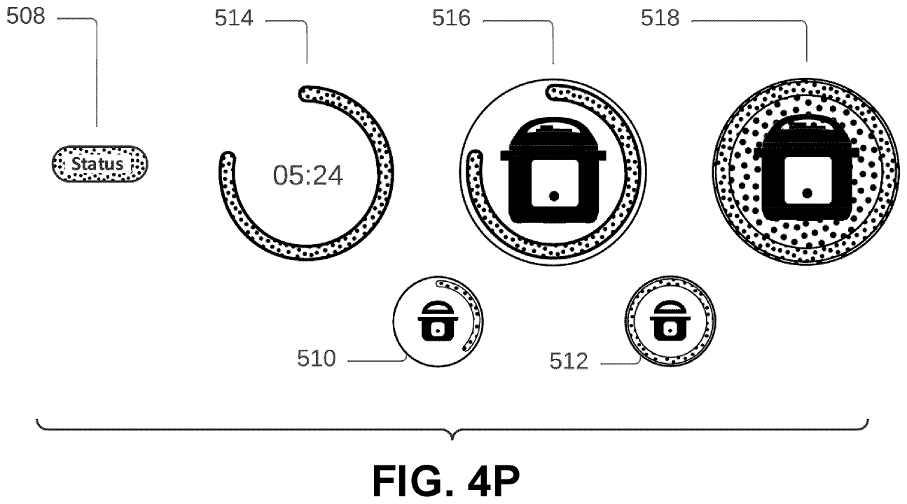

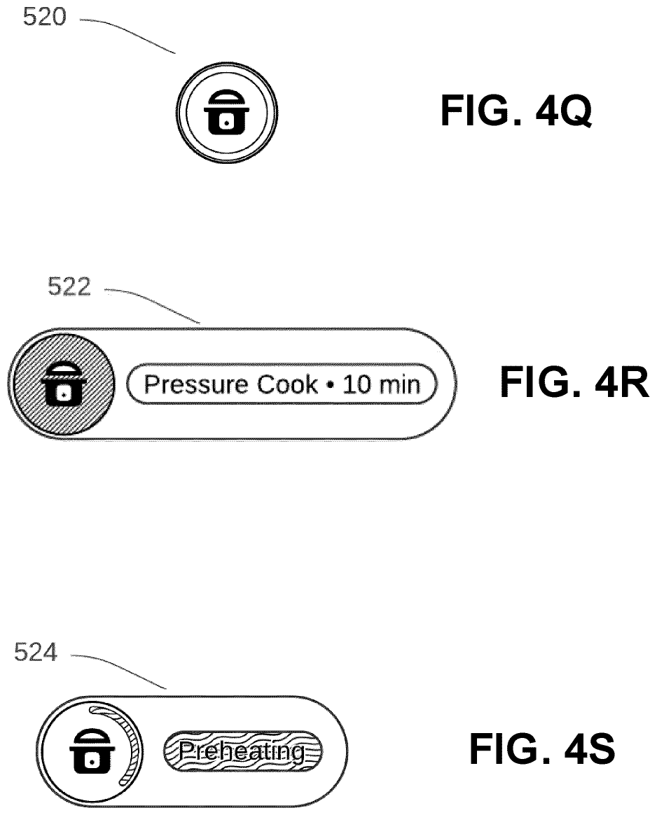

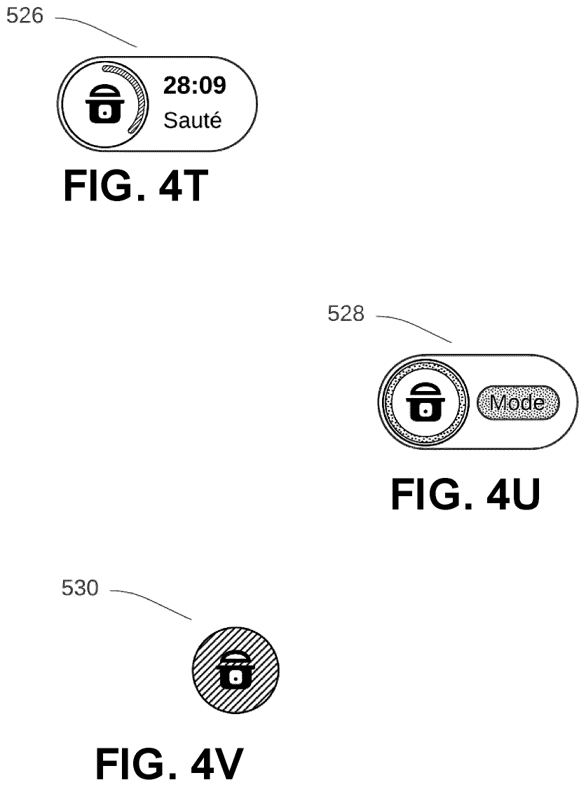

For example, as shown in FIG. 4A, a so-called “dynamic action button” may appear in a standard place on a recipe step and be used to execute whatever action the step represents. Depending on the context, this may represent an in-app action or may be delegated to varied appliances and services via the recipe framework.

Sub-processes in a recipe may have standard representations, both within the recipe user interface (216 and 246) and as visible elements presented elsewhere when the recipe user interface is not shown by the device or appliance—for example, as a lock screen widget on a mobile device. These sub-process representations may change as the processes progress. These sub-processes may map onto various cooking processes for different appliances, and they may represent actions to be followed by the user as prompted by the recipe interface. These representations may show progress through standard phases (e.g., precook, cook, and post-cook) and represent progress through these processes in several standard ways (e.g., progress represented as time, temperature, as a fraction or percentage, or as a continuous action).

An exemplary set of standardized icons and widgets is shown in FIGS. 4B-4V.

Widgets may be displayed in several ways, depending on context.

An exemplary standardized format for widgets is shown in FIG. 4B. The widgets 402, 404 in FIG. 4B are sometimes referred to as an “appliance pill.” An exemplary appliance pill may have three components: a progress indicator, time remaining, and mode display.

The widgets 402, 404 may include an appliance status and progress indicator 406, an indication of time remaining 408, and a mode 410. When time is being counted, the remaining time (408) is preferably shown. The mode 410 may display the name of the active mode (discussed below).

The status badge may be used to show the status of an appliance in written format (e.g., as shown in FIG. 4C, “Pressure Cooking” 412, “Sauté” 414, “Preheating” 416). The color of the badge may also be used to indicate information. A small progress indicator (e.g., a small progress circle, see e.g., the small progress circles 418, 420, 422 in FIG. 4D) may be used when the appliance is considered secondary content on the screen (e.g., during guided cooking). The color of the progress indicator may also be used to indicate information. A large progress indicator may be used when the appliance status is considered primary content on the screen (e.g., large progress circle 424, FIG. 4E).

### Size

An appliance is represented by an appropriately sized widget depending on the context in which it is displayed. For example, a badge may be used to display the status of an appliance as a small text badge within a colored “pill” (an “appliance pill”) representing status. A small badge or icon may be used where appliance status is considered secondary content on the screen. It may also be used as the OS lock screen representation where possible.

While different sizes may be used in different locations on a display or to convey information, the drawings are not to scale, and the relative sizes of the various icons and widgets may differ in implementations hereof.

Various status and progress types may represent appliance activity, e.g., static, counting, and continuous, as summarized in the table below:

| Type | Description |
|---|---|
| static | The appliance is inactive. |
| | Static modes may remain until a user triggers a different mode |
| | or the appliance detects an error or update. |
| | Example static statuses 426, 428, and 430 are shown in FIG. |
| | 4F. |
| counting | The appliance is executing an action that can be measured by |
| | progress, e.g., towards a time, temperature, or percentage |
| | target. |
| | Counting modes may count up or down from a certain time or |
| | percentage. |
| | Timed modes may display the remaining time within a slider. |
| | Percentage modes may display the appliance image within a |
| | slider. |
| | Example counting statuses 432, 434, 436, and 438 are shown |
| | in FIG. 4G. |
| continuous | The appliance is executing an action that continues until |
| | complete without measurement. |
| | Continuous modes may not have a set time or percentage and |
| | run until the mode is complete or the appliance switches |
| | mode. |
| | Examples of continuous statuses 440, 442, and 444 are shown |
| | in FIG. 4H. |

An icon or widget may display device status (e.g., detailed context as to the appliance state), as summarized, e.g., in the following table:

| Status | Discussion | Examples in Drawings |
|---|---|---|
| positive | The appliance is ready for use | FIG. 4I: |
| | | Example status: “Ready” |
| | | Example Status badge 448 |
| | | Example Appliance status indicators (large, |
| | | small): 450, 452 |
| negative | The appliance is offline, | FIG. 4J |
| | requires an update, or requires | Example status: “Offline,” “Update required” |
| | user input, e.g., opening its lid | Example Status badge 454 |
| | | Example Appliance status indicators (large, |
| | | small): 456, 458 |
| error | In a state of failure, the | FIG. 4K |
| | appliance cannot be used | Example status: “Update failed,” “Appliance |
| | | Stopped” |
| | | Example Status badge: 460 |
| | | Example Appliance status indicators (large, |
| | | small): 462, 464 |
| waiting | The appliance is expected to | FIG. 4L |
| | become ready, e.g., after a | Example status: “Waiting for appliance” |
| | firmware update, during | Example Status badge: 466 |
| | provisioning. | Example Appliance status indicators (large, |
| | | small): 468, 470 |
| Updates/ | The appliance is completing a | FIG. 4M |
| updating | firmware update. This may be | Example status: “Updating firmware” |
| | represented as a continuous or | Example Status badge: 472 |
| | counting action, depending on | Example Appliance status indicators (small): |
| | the appliance. | 474, 476 |
| | | Example Appliance status indicators (large): |
| | | 478, 480, 482 |
| precooking | The appliance is active and | FIG. 4N |
| | preparing to begin a cooking | Example status: “Preheating” |
| | action (e.g., pre-heating). This | Example Status badge: 484 |
| | may be represented as a | Example Appliance status indicators (small): |
| | continuous or counting action. | 486, 488 |
| | | Example Appliance status indicators (large): |
| | | 490, 492, 494 |
| cooking | The appliance is currently | FIG. 4O |
| | executing a cooking action, | Example status: “Pressure cooking” |
| | which may be represented as a | Example Status badge: 496 |
| | continuous or counting action. | Example Appliance status indicators (small): |
| | | 498, 500 |
| | | Example Appliance status indicators (large): |
| | | 502, 504, 506 |
| Post- | The appliance has finished and | FIG. 4P |
| cooking | is executing a post-cooking | Example status: “Venting,” “Keep warm” |
| | action, e.g., venting or keeping | Example Status badge: 508 |
| | warm. The post-cooking action | Example Appliance status indicators (small): |
| | may be represented as | 510, 512 |
| | continuous or counting | Example Appliance status indicators (large): |
| | | 514, 516, 518 |

Exemplary status icons/widgets (or badges) 520, 522, 524, 526, 528, and 530 are shown in FIGS. 4Q-4V, respectively. In presently preferred implementations, the color of the text and/or background in a status indicator may also be used to represent status. The icons on the user interface (corresponding to buttons and/or widgets) may illustrate appliances' statuses and cooking phases (e.g., in places like the lock screen).

### User and Helper Interface

The user interface may present contextual information to the user, e.g., when user input is required or desired.

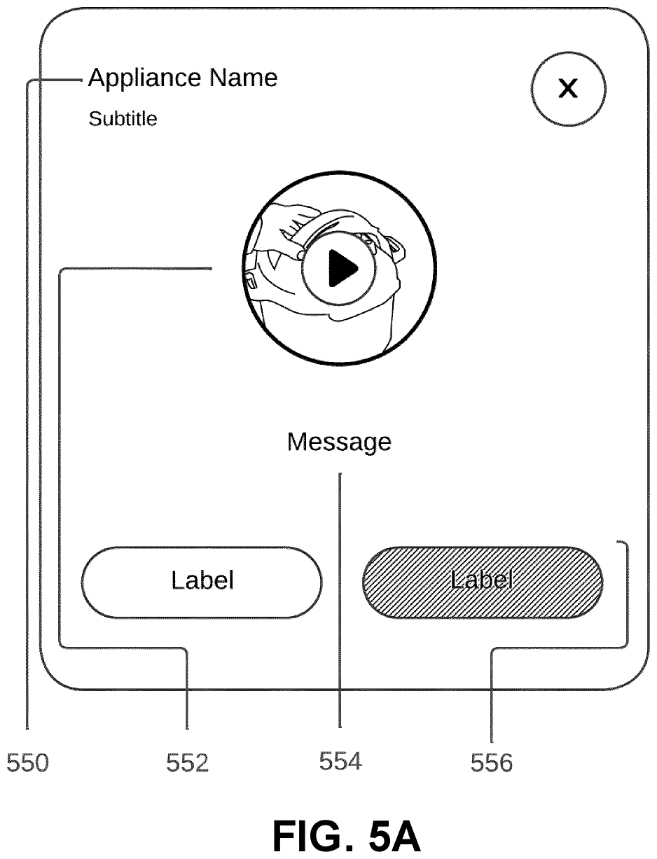

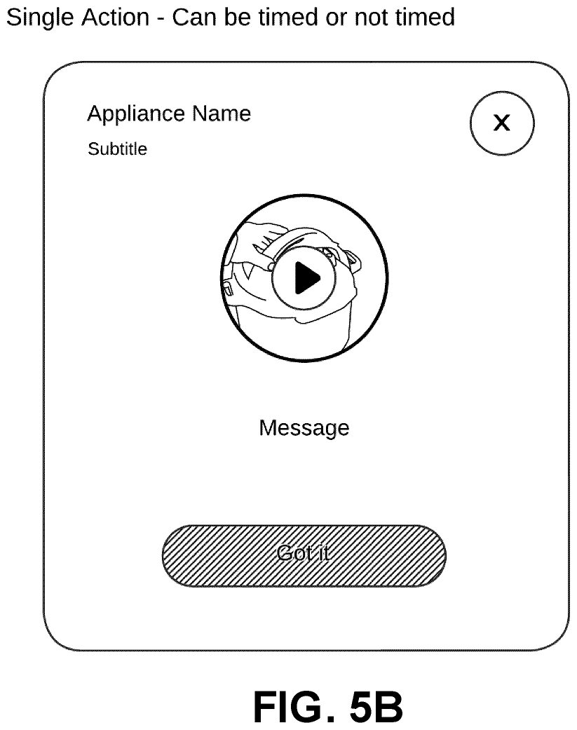

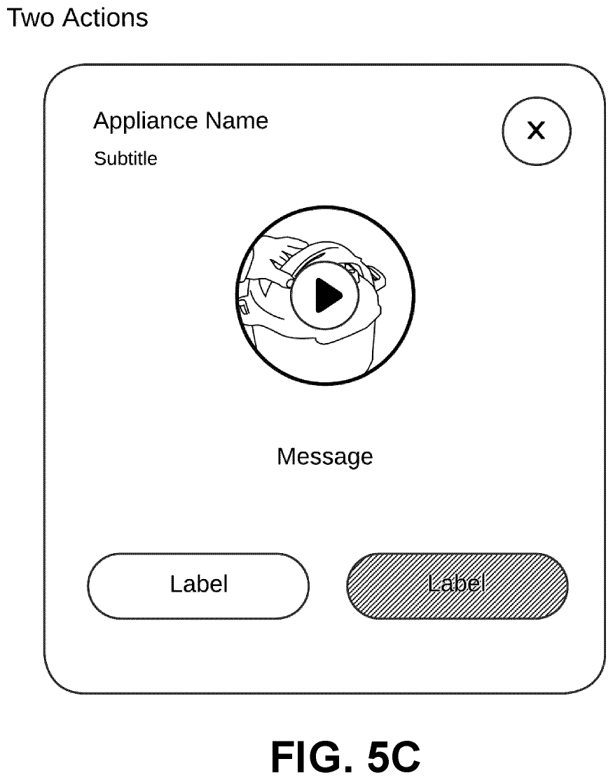

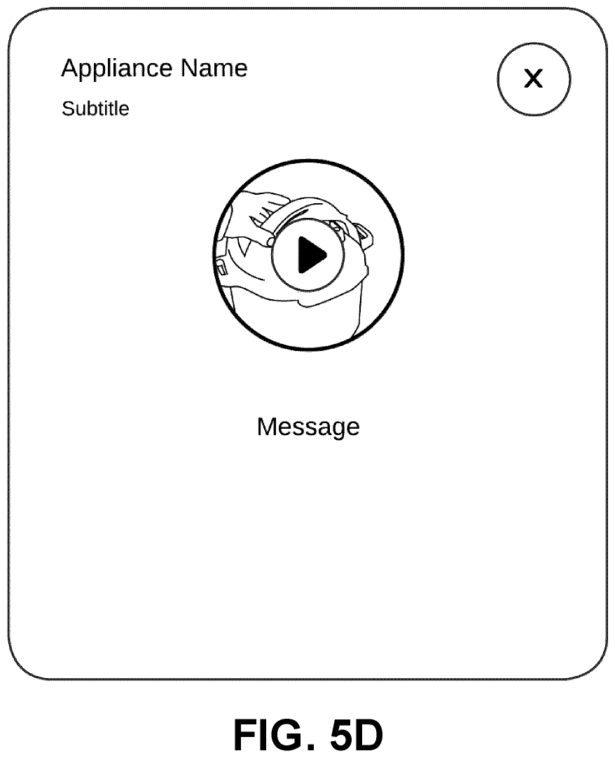

FIG. 5A shows a standardized format for presenting information and requesting information/input from a user. The system may present the appliance name 550, media or appliance progress 552, a message 554, and zero or more actions 556. The media or appliance progress 552 may use a media container to display an image or video and/or an appliance progress indicator to show the appliance progress. The message 554 may be a text message providing the user with guidance on what to do next. The action 556 (if present) may be, e.g., a single action (timed or not timed) (FIG. 5B) or two actions (FIG. 5C). An example with no actions is shown in FIG. 5D.

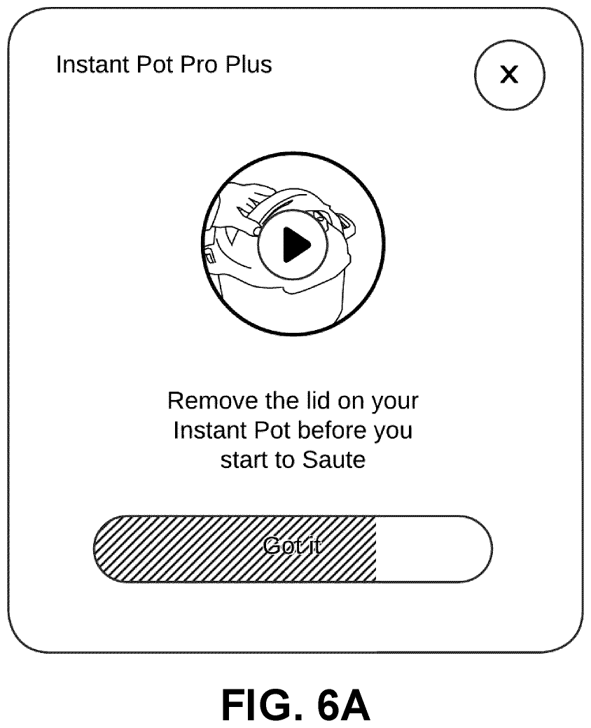

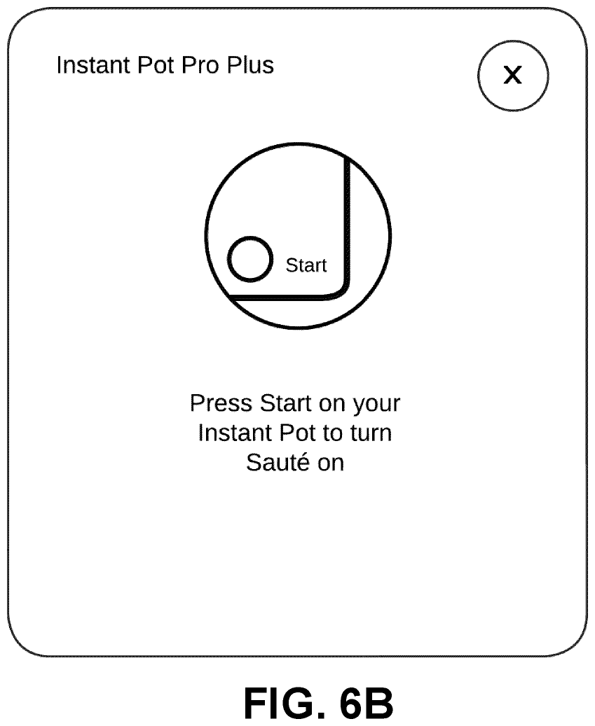

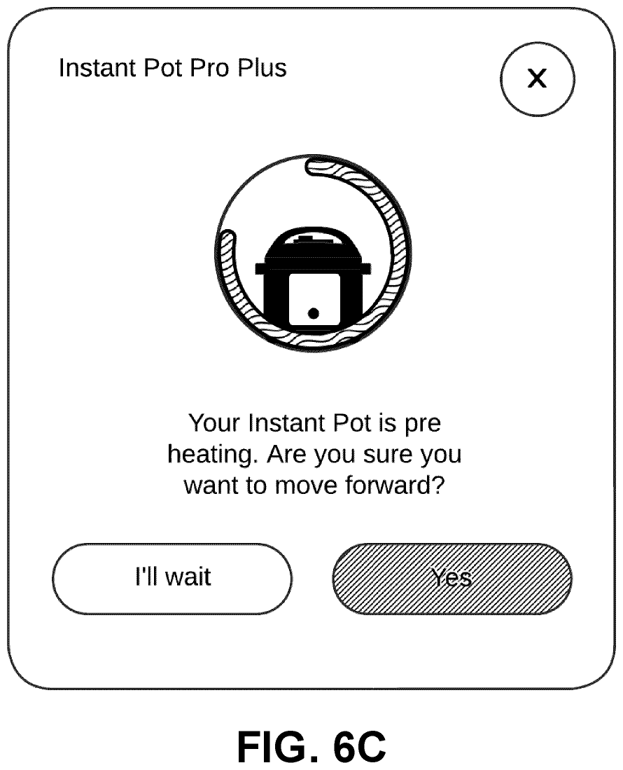

Examples are shown in FIGS. 6A-6C, and the following is a list of exemplary information that may be provided or conveyed using widgets:

| | |
|---|---|
| 1 | Oven - Precook, Bake |
| | Label = Preheat |
| | Color = Orange |
| | Type = % (where there is a temperature probe) |
| 2 | Oven - Cooking, Bake |
| | Label = Bake |
| | color = Green |
| | Type = Time |
| 3 | Oven - Post cooking, cooling down |
| | Label = Cooling down |
| | color = Yellow |
| | Type = % (where there is a temperature probe) |
| 4 | Precook and pressure cook with quick venting |
| | Label = preheat |
| | color = Orange |
| | Type = % |
| 5 | Cook, Pressure cook with quick venting |
| | Label = Pressure cook |
| | color = Green |
| | Type = Time |
| 6 | Post cook, Pressure cook with quick venting |
| | Label = Bake |
| | color = Yellow |
| | Type = Continuous |

While various colors are used in the example widgets and icons, and the colors may convey information, those of skill in the art will understand, upon reading this description, that different and/or other colors may be used.

### Smart Summary Step

The UI may provide the user with a dynamic summary of ingredients and preparations that may be used to pre-prepare.

### Overview Mode

The UI may provide an overview mode in which, instead of viewing the steps of a guided recipe in full detail with instructions, the user may choose to “zoom out” to a summary, facilitating the user to gain an overview or to skip ahead and review subsequent steps.

### Personalized Favorites

The UI may support the user setting personalized favorites. In this mode, when a user alters the default settings of an appliance program, the UI presents the user with an option to store the current settings as a favorite and subsequently recall it by name. In this manner, users can send their favorite settings with one tap or command. This approach can support several steps spanning multiple appliances.

Recall, as described above (with reference to FIG. 3A), a connected recipe comprises a list of ingredients 318 and a list of steps 316. Some steps require input (of one or more ingredients from the list of ingredients or the output of a previous step). Some steps may require the use of an appliance. Some steps may depend on the completion of other steps.

As the user progresses through a recipe, the user may switch between user devices 108 and appliances 110. As should be appreciated, to maintain consistency across devices and appliances, a true (actual) version of the recipe's progress and state is required. Accordingly, the recipe framework 102 (e.g., using synchronization mechanism 130) maintains the current and true state of the recipe's progress, e.g., as state/progress 350 in the user data 340 (FIG. 3C) in the user database 146. The synchronization mechanism 130 may obtain state data from the user's devices 108 and appliances 110. When a device or appliance comes online or is being used, it interfaces with the synchronization mechanism 130 to get the true state of the recipe's progress. The state/progress of the recipe maintained by the recipe framework 102 is considered “true” in that, in the event of any discrepancy between different versions of the state/progress of the recipe, the state/progress maintained by the recipe framework 102 will govern.

A user may switch devices while using a recipe, with each device being in the correct place (at the correct stage or step) of the recipe. For example, a user may search for a recipe on their cell phone (a device 108) while away from home, using a recipe program 214 (e.g., an app) on their phone and interacting with the search mechanism 128 on the recipe framework 102. The search mechanism 128 may search the recipes database 140, from which the user may select a particular connected recipe. In the user database 146, for that user, the selected recipe will be stored as the recipe in use 354, and the state/progress data 350 will record the current progress in the recipe 356.

The recipe user interface 216 on the user's phone may present information about that particular recipe, including the ingredient list. The user may acquire needed ingredients and then go home. The user may switch from their phone to a tablet device (e.g., an Apple iPad) at home. The tablet device also runs a version of the recipe program 214 and uses the state/progress data 350 stored in the user database 146 for that user, and that recipe will position the user at the correct location in the recipe.

The user may use a particular connected appliance 110 to perform some recipe steps (e.g., boil water or roast a chicken). The particular connected appliance 110 may connect directly with the recipe framework 102 to obtain the current state of the recipe (so that a display on the appliance can present current recipe information to the user). The appliance may also communicate its state (e.g., oven temperature, etc.) back to the recipe framework 102. The recipe framework 102 may update the recipe's status based on information communicated from the device.

As the user progresses through the recipe, each device and appliance used with the recipe framework 102 will maintain synchronization with the recipe's state as stored in the recipe framework 102.

If a particular user device 104 does not have or support a recipe program, e.g., if the device is a general-purpose computer such as a laptop computer, the user may interact with the recipe framework 102 with an interaction widget running, e.g., on top of a browser. As noted above, this approach is amenable to presenting recipes in an app or other contexts, for example, on the user interface of an appliance equipped with a screen (e.g., a color touchscreen), with an SDK embedded in another app, on the display of a touchscreen-enabled appliance, as a widget layer presented upon the original recipe, or via a home voice assistant.

As noted earlier, a “widget” may be a graphical user interface component that displays information and/or enables a user to interact with an application in a specific way. A widget may refer to code (software) that implements aspects of the interaction and information display. For example, an interaction widget may refer to code (software) that implements aspects of the recipe interaction that encapsulate the functionality of the recipe application. The interaction widget allows the user to access the recipe framework 102 without a specialized application.

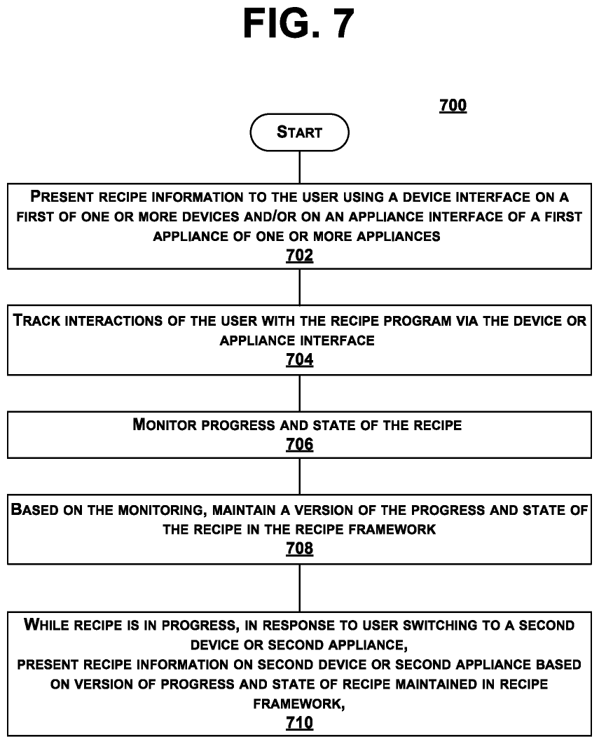

FIG. 7 is a flowchart of an exemplary process 700 of using a connected recipe on multiple devices and/or appliances. The process 700 in FIG. 7 operates, e.g., in a system in which a recipe is stored on a recipe framework, and includes, by a user having one or more devices and one or more appliances:

A recipe program presenting recipe information (at 702) to the user using a device interface on a first of the one or more devices and/or on an appliance interface of a first appliance of the one or more appliances. The process also includes (at 704) tracking user interactions with the recipe program via the device interface or the appliance interface. The process also includes (at 706) monitoring the progress and state of the recipe. The process also includes (at 708), based on the monitoring, maintaining in the recipe framework, a version of the progress and state of the recipe. The process further includes (at 710), while the recipe is in progress, and in response to the user switching to a second device of the one or more devices and/or to a second appliance of the one or more appliances, presenting recipe information on the second device and/or on the second appliance based on the version of the progress and state of the recipe maintained in the recipe framework, wherein the second device or second appliance obtains the version of the progress and state from the recipe framework. During the recipe process, the device and appliance user interfaces present a consistent and contextual view of the state of the recipe.

As described herein, users may interact with the recipe framework by choosing a preset recipe supported by a single appliance. In this case, this appliance becomes the primary focus of the content. Rather than presenting appliance interaction within the steps of a recipe, such a recipe may be represented more simply as a set of actions to be followed using an appliance. Those skilled in the art will appreciate and understand, upon reading this description, that this alternative presentation mechanism may be generated by the same recipe framework and is still distributed and governed between different client devices in the same manner as a connected recipe.

### Computing

The applications, services, mechanisms, operations, and acts shown and described above are implemented, at least in part, by software running on one or more computers.

Programs that implement such methods (as well as other types of data) may be stored and transmitted using various media (e.g., computer-readable media) in several manners. Hard-wired circuitry or custom hardware may be used in place of, or in combination with, some or all of the software instructions that can implement the processes of various embodiments. Thus, various combinations of hardware and software may be used instead of software only.

One of ordinary skill in the art will readily appreciate and understand, upon reading this description, that the various processes described herein may be implemented by, e.g., appropriately programmed general-purpose computers, special-purpose computers, and computing devices. One or more such computers or computing devices may be referred to as a computer system.

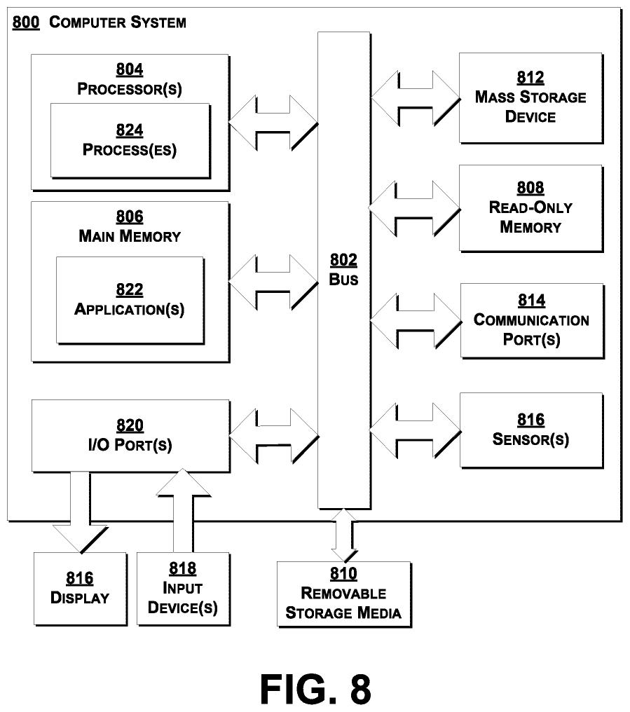

FIG. 8 is a schematic diagram of a computer system 800 upon which embodiments of the present disclosure may be implemented and carried out.

According to the present example, the computer system 800 includes a bus 802 (i.e., interconnect), one or more processors 804, a main memory 806, read-only memory 808, removable storage media 810, mass storage 812, and one or more communications ports 814. Communication port(s) 814 may be connected to one or more networks (not shown) by way of which the computer system 800 may receive and/or transmit data.

As used herein, a “processor” means one or more microprocessors, central processing units (CPUs), computing devices, microcontrollers, digital signal processors, or like devices or any combination thereof, regardless of their architecture. An apparatus that performs a process can include, e.g., a processor and those devices such as input and output devices that are appropriate to perform the process.

Processor(s) 804 can be any known processor(s) (e.g., including, without limitation, processors and microcontrollers based on the ARM, Risc-V, and Xtensa architectures). Communications port(s) 814 can be any of an Ethernet port, a Gigabit port using copper or fiber, a USB port, and the like. Communications port(s) 814 may be chosen depending on a network such as a Local Area Network (LAN), a Wide Area Network (WAN), a low-rate wireless personal area network (LR-WPAN), or any network to which the computer system 800 connects. The computer system 800 may be in communication with peripheral devices (e.g., display screen 816, input device(s) 818) via Input/Output (I/O) port 820.

Main memory 806 can be Random Access Memory (RAM) or any other dynamic storage device(s) commonly known in the art. Read-only memory (ROM) 808 can be any static storage device(s), such as Programmable Read-Only Memory (PROM) chips for storing static information, such as instructions for the processor(s) 804. Mass storage 812 can be used to store information and instructions. For example, hard disk drives, optical discs, an array of disks such as Redundant Array of Independent Disks (RAID), or other mass storage devices.

Bus 802 communicatively couples processor(s) 804 with the other memory, storage, and communications blocks. Bus 802 can be a PCI/PCI-X, SCSI, a Universal Serial Bus (USB) based system bus (or other) depending on the storage devices used and the like. Removable storage media 810 can be any kind of external storage, including hard drives, floppy drives, USB drives, Compact Disc-Read-Only Memory (CD-ROM), Compact Disc-ReWritable (CD-RW), Digital Versatile Disk-Read Only Memory (DVD-ROM), etc.

Embodiments herein may be provided as one or more computer program products, which may include a machine-readable medium having stored thereon instructions, which may be used to program a computer (or other electronic devices) to perform a process. As used herein, the term “machine-readable medium” refers to any medium, a plurality of the same, or a combination of different media, which participate in providing data (e.g., instructions, data structures) that may be read by a computer, a processor or a like device. Such a medium may take many forms, including but not limited to non-volatile media, volatile media, and transmission media. Non-volatile media include, for example, optical or magnetic disks and other persistent memory. Volatile media include dynamic random access memory, which typically constitutes the computer's main memory. Transmission media include coaxial cables, copper wire, and fiber optics, including the wires that comprise a system bus coupled to the processor. Transmission media may include or convey acoustic waves, light waves, and electromagnetic emissions, such as those generated during radio frequency (RF) and infrared (IR) data communications.

The machine-readable medium may include but is not limited to, floppy diskettes, optical discs, CD-ROMs, magneto-optical disks, ROMs, RAMs, erasable programmable read-only memories (EPROMs), electrically erasable programmable read-only memories (EEPROMs), magnetic or optical cards, flash memory, or other types of media/machine-readable medium suitable for storing electronic instructions. Moreover, embodiments herein may also be downloaded as a computer program product. The program may be transferred from a remote computer to a requesting computer by way of data signals embodied in a carrier wave or other propagation medium via a communication link (e.g., modem or network connection).

Various forms of computer-readable media may carry data (e.g., sequences of instructions) to a processor. For example, data may be (i) delivered from RAM to a processor, (ii) carried over a wireless transmission medium, (iii) formatted and/or transmitted according to numerous formats, standards, or protocols, and/or (iv) encrypted in any of a variety of ways well known in the art.

A computer-readable medium can store (in any appropriate format) the appropriate program elements to perform the methods.

As shown, main memory 806 is encoded with application(s) 822 that support(s) the functionality as discussed herein (the application(s) 822 may be an application(s) that provides some or all of the functionality of the services/mechanisms described herein). Application(s) 822 (and/or other resources as described herein) can be embodied as software code such as data and/or logic instructions (e.g., code stored in the memory or on another computer-readable medium such as a disk) that supports processing functionality according to different embodiments described herein.

During the operation of one embodiment, processor(s) 804 accesses main memory 806 via bus 802 to launch, run, execute, interpret, or otherwise perform the logic instructions of the application(s) 822. Execution of application(s) 822 produces processing functionality of the service related to the application(s). In other words, the process(es) 824 represents one or more portions of the application(s) 822 performing within or upon the processor(s) 804 in the computer system 800.

It should be noted that in addition to the process(es) 824 that carries (carry) out operations as discussed herein, other embodiments herein include the application 822 itself (i.e., the unexecuted or non-performing logic instructions and/or data). The application 822 may be stored on a computer-readable medium (e.g., a repository) such as a disk or in an optical medium. According to other embodiments, the application 822 can also be stored in a memory type system such as in firmware, read-only memory (ROM), or, as in this example, as executable code within the main memory 806 (e.g., within Random Access Memory or RAM). For example, application(s) 822 may also be stored in removable storage media 810, read-only memory 808, and/or mass storage device 812.

Those skilled in the art will understand that the computer system 800 can include other processes and/or software and hardware components, such as an operating system that controls the allocation and use of hardware resources.

As discussed herein, embodiments of the present invention include various steps or operations. A variety of these steps may be performed by hardware components or embodied in machine-executable instructions, which may be used to cause a general-purpose or special-purpose processor programmed with the instructions to perform the operations. Alternatively, the steps may be performed by a combination of hardware, software, and/or firmware. The term “module” refers to a self-contained functional component, including hardware, software, firmware, or any combination thereof.

One of ordinary skill in the art will readily appreciate and understand, upon reading this description, that embodiments of an apparatus may include a computer/computing device operable to perform some (but not necessarily all) of the described process.

Embodiments of a computer-readable medium storing a program or data structure include a computer-readable medium storing a program that, when executed, can cause a processor to perform some (but not necessarily all) of the described process.

Where a process is described herein, those of ordinary skill in the art will appreciate that the process may operate without any user intervention. In another embodiment, the process includes some human intervention (e.g., a step is performed by or with the assistance of a human).

### CONCLUSION

Where a process is described herein, those of ordinary skill in the art will appreciate that the process may operate without any user intervention. In another embodiment, the process includes some human intervention (e.g., an act is performed by or with the assistance of a human).

As used herein, including in the claims, the phrase “at least some” means “one or more” and includes the case of only one. Thus, e.g., the phrase “at least some ABCs” means “one or more ABCs” and includes the case of only one ABC.

As used herein, including in the claims, the term “at least one” should be understood as meaning “one or more,” and therefore includes both embodiments that include one or multiple components. Furthermore, dependent claims that refer to independent claims that describe features with “at least one” have the same meaning, both when the feature is referred to as “the” and “the at least one.”

As used herein, including in the claims, the phrase “using” means “using at least” and is not exclusive. Thus, e.g., the phrase “using x” means “using at least x.” Unless specifically stated by the use of the word “only,” the phrase “using x” does not mean “using only x.”

As used herein, including in the claims, the phrase “based on” means “based in part on” or “based, at least in part, on,” and is not exclusive. Thus, e.g., the phrase “based on factor x” means “based in part on factor x” or “based, at least in part, on factor x.” Unless specifically stated by the use of the word “only,” the phrase “based on x” does not mean “based only on x.”

In general, as used herein, including in the claims, unless the word “only” is specifically used in a phrase, it should not be read into that phrase.

As used herein, including in the claims, the phrase “distinct” means “at least partially distinct.” Unless specifically stated, distinct does not mean fully distinct. Thus, e.g., the phrase, “x is distinct from Y” means that “x is at least partially distinct from Y” and does not mean that “x is fully distinct from Y.” Thus, as used herein, including in the claims, the phrase “x is distinct from Y” means that x differs from Y in at least some way.

It should be appreciated that the words “first,” “second,” and so on, in the description and claims are used to distinguish or identify and not to show a serial or numerical limitation. Similarly, letter labels (e.g., “(A),” “(B),” “(C),” and so on, or “(a),” “(b),” and so on) and/or numbers (e.g., “(i),” “(ii),” and so on) are used to assist in readability and to help distinguish and/or identify and are not intended to be otherwise limiting or to impose or imply any serial or numerical limitations or orderings. Similarly, words such as “particular,” “specific,” “certain,” and “given” in the description and claims, if used, are to distinguish or identify and are not intended to be otherwise limiting.

As used herein, including in the claims, the terms “multiple” and “plurality” mean “two or more” and include the case of “two.” Thus, e.g., the phrase “multiple ABCs” means “two or more ABCs” and includes “two ABCs.” Similarly, e.g., the phrase “multiple PQRs” means “two or more PQRs” and includes “two PQRs.”

The present invention also covers the exact terms, features, values, and ranges, etc., in case these terms, features, values, and ranges, etc. are used in conjunction with terms such as about, around, generally, substantially, essentially, at least, etc. (for example, “about 3” or “approximately 3” shall also cover exactly 3 or “substantially constant” shall also cover exactly constant).

As used herein, including in the claims, singular forms of terms are to be construed as also including the plural form and vice versa unless the context indicates otherwise. Thus, it should be noted that as used herein, the singular forms “a,” “an,” and “the” include plural references unless the context clearly dictates otherwise.

Throughout the description and claims, the terms “comprise,” “including,” “having,” and “contain” and their variations should be understood as meaning “including but not limited to” and are not intended to exclude other components unless specifically so stated.

It will be appreciated that variations to the embodiments of the invention can be made while still falling within the scope of the invention. Alternative features serving the same, equivalent, or similar purpose can replace features disclosed in the specification unless stated otherwise. Thus, unless stated otherwise, each feature disclosed represents one example of a generic series of equivalent or similar features.

Use of exemplary language, such as “for instance,” “such as,” “for example” (“e.g.,”) and the like, is merely intended to illustrate the invention better and does not indicate a limitation on the scope of the invention unless specifically so claimed. The abbreviation “i.e.” means “that is.”

While a particular feature of the invention may have been disclosed with respect to only one of several implementations, such feature may be combined with one or more other features of the other implementations as may be desired and advantageous for any given or particular application. Furthermore, to the extent that the terms “includes,” “including,” and variants thereof are used in either the detailed description or the claims, these terms are intended to be inclusive in a manner similar to the term “comprising.”

While the invention has been described in connection with what is presently considered to be the most practical and preferred embodiments, it is to be understood that the invention is not to be limited to the disclosed embodiment but, on the contrary, is intended to cover various modifications and equivalent arrangements included within the spirit and scope of the appended claims.

Appendix A
A Connected (Smart) Recipe

prep_time: P0DT0H15M0S
cook_time: P0DT0H10M0S
total_time: P0DT0H25M0S
name: Quick Chocolate Chip Cookies
source_url: https://share.frescocooks.com/nnVON00sSqb
description: Quick and easy cookies with the perfect hit of melting
chocolate.
difficulty: 2
ingredients:
source_text: 140 g Unsalted butter
reference_ingredient_id: cckg:UnsaltedButter
reference_preparation_ids:
cckg:RoomTemperature
quantity:
amount: 145
reference_unit_id: cckg:Gram
source_text: 55 g Granulated sugar
reference_ingredient_id: cckg:GranulatedSugar
quantity:
amount: 54
reference_unit_id: cckg:Gram
source_text: 140 g Brown sugar
reference_ingredient_id: cckg:BrownSugar
quantity:
amount: 145
reference_unit_id: cckg:Gram
source_text: 1 Egg
reference_ingredient_id: cckg:Egg
quantity:
amount: 50
reference_unit_id: cckg:Gram
source_text: 5 g Vanilla extract
reference_ingredient_id: cckg:VanillaExtract
quantity:
amount: 5
reference_unit_id: cckg:Gram
source_text: 220 g All-purpose flour
reference_ingredient_id: cckg:AllPurposeFlour
quantity:
amount: 218
reference_unit_id: cckg:Gram
source_text: 5 g Sea salt
reference_ingredient_id: cckg:SeaSalt
quantity:
amount: 5
reference_unit_id: cckg:Gram
source_text: 5 g Baking soda
reference_ingredient_id: cckg:BakingSoda
quantity:
amount: 5
reference_unit_id: cckg:Gram
source_text: 180 g Chocolate chips
reference_ingredient_id: cckg:ChocolateChips
quantity:
amount: 181
reference_unit_id: cckg:Gram
steps:
source_text: Add unsalted butter, granulated sugar and brown sugar to a
clean, large mixing bowl
text: Add unsalted butter, granulated sugar and brown sugar to a clean,
large mixing bowl
ingredients:
ingredient idx: 0
quantity:
amount: 145
reference_unit_id: cckg:Gram
ingredient_idx: 1
quantity:
amount: 54
reference_unit_id: cckg:Gram
ingredient_idx: 2
quantity:
amount: 145
reference_unit_id: cckg:Gram
source_text: Cream until smooth
text: Cream until smooth
source_text: Add egg and vanilla extract to the dough
text: Add egg and vanilla extract to the dough
ingredients:
ingredient_idx: 3
quantity:
amount: 50
reference_unit_id: cckg:Gram
ingredient_idx: 4
quantity:
amount: 5
reference_unit_id: cckg:Gram
source_text: Mix until well combined
text: Mix until well combined
source_text: Add all-purpose flour, sea salt, and baking soda to the
dough
text: Add all-purpose flour, sea salt, and baking soda to the dough
ingredients:
ingredient_idx: 5
quantity:
amount: 218
reference_unit_id: cckg:Gram
ingredient_idx: 6
quantity:
amount: 5
reference_unit_id: cckg:Gram
ingredient_idx: 7
quantity:
amount: 5
reference_unit_id: cckg:Gram
source_text: Mix until well blended
text: Mix until well blended
source_text: Add chocolate chips to the dough
text: Add chocolate chips to the dough
ingredients:
ingredient_idx: 8
quantity:
amount: 181
reference_unit_id: cckg:Gram
source_text: Mix until just combined
text: Mix until just combined
source_text: Chill in freezer
text: Chill in freezer
source_text: Pre-heat oven −175° C.
text: Pre-heat oven −175° C.
source_text: Line a clean baking sheet with parchment paper
text: Line a clean baking sheet with parchment paper
source_text: Scoop dough onto baking sheet
text: Scoop dough onto baking sheet
source_text: Bake until golden brown −11 min, 175° C.
text: Bake until golden brown −11 min, 175° C.
capability:
reference_capability_id: cckg:Bake
settings:
reference_setting_id: cckg:TemperatureSetting
value:
type: number
value: 175
reference_unit_id: cckg:Celsius
source_text: Let cool
text: Let cool
source_text: Serve
text: Serv

1. A method in a system in which a recipe is stored on a recipe framework, the method comprising, by a user having one or more devices and one or more appliances, at least some of said one or more devices having corresponding device user interfaces, and at least some of said one or more appliances having corresponding appliance user interfaces, the method comprising:
a recipe program presenting recipe information to the user using a device user interface on a first of said one or more devices and/or on an appliance user interface of a first appliance of said one or more appliances;
tracking interactions of the user with the recipe program via the device user interface or the appliance user interface;
monitoring progress and state of the recipe;
based on said monitoring, maintaining in said recipe framework a version of the progress and state of the recipe; and
while the recipe is in progress, and in response to the user switching to a second device of said one or more devices and/or to a second appliance of said one or more appliances, presenting recipe information on a second device user interface and/or on a second appliance user interface based on the version of the progress and state of the recipe maintained in the recipe framework, wherein the second device or second appliance obtains the version of the progress and state from the recipe framework,
wherein the device user interfaces and the appliance user interfaces present a consistent and contextual view of the state of the recipe,
wherein the version of the progress and state of the recipe maintained in the recipe framework is considered a true version of the progress and state of the recipe, and
wherein, if there is a discrepancy between versions of the progress and state of the recipe, the progress and state maintained by the recipe framework will govern, and wherein the recipe framework is accessible via one or more interfaces and
wherein a device or appliance obtains the true version of the progress and state from the recipe framework via said one or more interfaces, and
wherein the true version of the progress and state of the recipe is based on received streams of events and/or state data coming from the one or more devices and/or the one or more appliances.

2. The method of claim 1, wherein the device user interfaces and the appliance user interfaces comprise one or more contextual icons or widgets, said icons or widgets representing appliance or user processes.

3. The method of claim 2, wherein at least some of said contextual icons or widgets correspond to virtual buttons or switches used to control aspects of said recipe and/or aspects of one or more appliances.

4. The method of claim 1, wherein the one or more devices are selected from:
a personal computer, a cell phone, a tablet computer, a desktop computer, a TV, a smartwatch, a voice assistant, or an appliance UI; and
wherein the one or more appliances are selected from cooking and food preparation appliances.

5-8. (canceled)

9. The method of claim 1, wherein state data from an appliance includes information about a current state of the appliance.

10. The method of claim 1, wherein the recipe comprises a list of one or more ingredients and a list of recipe steps, and wherein the state of the progress and state of the recipe comprises information about which recipe step or steps have been completed.

11. The method of claim 1, wherein the recipe framework determines which one or more appliances to use for the recipe based on information about appliances available to the user.

12. The method of claim 1, wherein a determination of which appliances to use for the recipe is made when the user selects the recipe, and using user data maintained by the recipe framework, the user data, including appliance data.

13. The method of claim 1, wherein the recipe determines which of the one or more appliances are to be used, and wherein a determination of which of the one or more appliances are to be used is made after the acts of the method are performed.

14. A non-transitory computer-readable medium with one or more computer programs stored therein that, when executed by one or more processors, cause the one or more processors to perform at least the operations of the method of claim 1.

15. An article of manufacture comprising non-transitory computer-readable media having computer-readable instructions stored thereon, the computer-readable instructions including instructions for implementing a computer-implemented method, said method operable on a device comprising hardware including memory and at least one processor and running a service on said hardware, said method comprising the method of claim 1.

16. A device comprising:
(a) hardware, including memory and at least one processor, and
(b) a service running on said hardware, wherein said service is configured to perform the method claim 1.

17. A system comprising at least one device according to claim 16.

18. A computer system configured to communicate with a recipe program presenting recipe information via a device user interface on a first of said one or more devices and/or on an appliance user interface of a first appliance of said one or more appliances, the system comprising:
one or more processors; and
memory storing one or more programs configured to be executed by the one or more processors, the one or more programs including instructions for:
tracking interactions of a user with the recipe program via the device user interface or the appliance user interface;
monitoring progress and state of the recipe;
based on said monitoring, maintaining in a recipe framework a version of the progress and state of the recipe; and
while the recipe is in progress, and in response to a user switching to a second device of said one or more devices and/or to a second appliance of said one or more appliances, presenting recipe information on a second device user interface and/or on a second appliance user interface based on the version of the progress and state of the recipe maintained in the recipe framework, wherein the second device or second appliance obtains the version of the progress and state from the recipe framework, and
wherein the device user interfaces and the appliance user interfaces present a consistent and contextual view of the state of the recipe, and
wherein the version of the progress and state of the recipe maintained in the recipe framework is considered a true version of the progress and state of the recipe, and
wherein, if there is a discrepancy between versions of the progress and state of the recipe, the progress and state maintained by the recipe framework will govern, and wherein the recipe framework is accessible via one or more interfaces, and
wherein a device or appliance obtains the true version of the progress and state from the recipe framework via said one or more interfaces, and
wherein the true version of the progress and state of the recipe is based on received streams of events and/or state data coming from the one or more devices and/or the one or more appliances.
